(19) United States
(12) Patent Application Publication
(10) Pub. No.: US 2026/0186833 A1
(43) Pub. Date: Jul. 2, 2026

(54) EVENT-DRIVEN ARCHITECTURE TO ORCHESTRATE ASYNCHRONOUS ACTIVITIES TO KEEP DATA UP-TO-DATE AT AN ADAPTIVELY VARIABLE, TYPE-SPECIFIC CADENCE BASED ON PROCESS CONTROL METADATA

(71) Applicant: Oracle International Corporation, Redwood Shores, CA (US)

(72) Inventors: Tej Dewangan, Redwood City, CA (US); Satya Anur, Redwood City, CA (US); Sunil Chawla, Redwood City, CA (US); Harshavardhan Takle, Redwood City, CA (US)

(73) Assignee: Oracle International Corporation, Redwood Shores, CA (US)

(21) Appl. No.: 19/332,274

(22) Filed: Sep. 18, 2025

Related U.S. Application Data
(60) Provisional application No. 63/740,720, filed on Dec. 31, 2024.

(51) Int. Cl. G06F 9/48; G06F 9/54

(52) U.S. Cl. CPC G06F 9/4887; G06F 9/542

(57) ABSTRACT

Methods, systems, and computer-readable media are provided for asynchronous process automation that efficiently manages asynchronous processes based on process control metadata to keep data up-to-date at an adaptively variable type-specific cadence based on process control metadata, eliminating the need for manual engagement to maintain operational activities. An event-driven framework is provided for the asynchronous process automation that includes AI agent(s) for interactions, along with a process management system that tracks pending potential work items due to one or more changes in source data. The process management system activates an asynchronous process management process after a wait period. The process management system then determines which pending potential work items to perform in an iteration of evaluation of the pending potential work items. The process control metadata includes stored limitations on a timing for performing individual processes. The process management system prioritizes processes based on process control metadata, such as prioritizing specific ones over others, including throttling certain other processes during high impact time-sensitive activities.

### CROSS-REFERENCE TO RELATED APPLICATIONS

This application claims the benefit of U.S. Provisional Ser. No. 63/740,720, filed on Dec. 31, 2024. The entire disclosure of the aforementioned application is incorporated by reference herein in its entirety for all purposes.

### BACKGROUND

Process automation is a critical value driver for software deployments, and the process automation may save companies more time and allow companies to provide better service than manual approaches. In many large-scale software deployments, manual approaches are no longer possible to provide an amount of functionality delivered in a manner that is up-to-date within timing constraints specified by the company. For example, thousands of processes that trigger based on updates to tens of thousands of records that occur daily or weekly may not be able to be manually performed, regardless of how many humans are tasked with manual performance of the corresponding tasks. Processes may perform complex logic that involves sub-processes, third party applications, and/or real-time data comparisons or computations that depend on transactionally consistent values and statuses, and such complex logic may be difficult or impossible to coordinate without a highly performant process automation system.

### BRIEF SUMMARY

In various embodiments, methods, systems, and computer-readable media are provided for asynchronous process automation that efficiently manages asynchronous processes to keep data up-to-date at an adaptively variable type-specific cadence based on process control metadata, eliminating the need for manual engagement to maintain operational activities. An event-driven framework is provided for the asynchronous process automation that includes an AI agent for interactions, along with a process management system that tracks pending potential work items due to one or more changes in source data. The process management system activates an asynchronous process management process after a wait period. The process management system then determines which pending potential work items to perform in an iteration of evaluation of the pending potential work items. The process control metadata includes stored limitations on a timing for performing individual processes. The process management system prioritizes processes based on process control metadata, such as prioritizing specific ones over others, including throttling certain other processes during high impact time-sensitive activities.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that efficiently manages asynchronous processes to reduce wasted cycles while maintaining current data for insights and decision-making.

FIG. 2 illustrates a system diagram showing an example cloud infrastructure that efficiently manages asynchronous processes to reduce wasted cycles while maintaining current data for insights and decision-making.

FIG. 3 illustrates a diagram of an example user interface showing a notification about an automated process that is not completing according to guidance specified in influencer metadata.

FIG. 4 illustrates a diagram of an example process management system architecture.

FIG. 5 illustrates a diagram of an example execution service.

FIG. 6 illustrates a flow chart showing an example continuous execution service process.

FIG. 7A depicts an example table storing influencer metadata for different processes.

FIG. 7B depicts an example table storing influencer metadata for different processes including a last and next column for tracking when a process type is due for execution.

FIG. 8 depicts a simplified diagram of a distributed system for implementing certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

FIG. 11 illustrates an example agentic architecture for executing work items from a pending work queue.

### DETAILED DESCRIPTION

A process management system is described herein for efficiently managing asynchronous processes to reduce wasted cycles while maintaining current data for insights and decision-making. The process management system may be called “centralized” or a “controller” in that the process management system manages process automation for multiple separate processes, each of which may be on different desired schedules or with different timing constraints. The managed data may be considered “current” by complying with timing constraints specified by the user or timing constraints determined from a separate schedule for the individual process. In various embodiments, the process management system is implemented using non-transitory computer-readable storage media to store instructions which, when executed by one or more processors of a computer system, cause processing of source data updates or pending work to automate downstream processes. The process management system may be implemented on a local or cloud-based computer system. The computer system may communicate with client computer systems to display results of automated processing and/or troubleshoot processes that encounter exceptions, fail to complete in a timeline specified in process control metadata, and/or get postponed within a specified timeline.

A description of the process management system is provided in the following sections:
WORKFLOWS AND BUSINESS PROCESS AUTOMATION
RESOURCE UTILIZATION FROM RUNNING PROCESSES ASYNCHRONOUSLY
AUTOMATED HANDLING OF POTENTIAL WORK TO REDUCE WASTED CYCLES
DETERMINING WHICH PROCESSES HAVE PENDING POTENTIAL WORK TO PERFORM
DETERMINING WHICH POTENTIAL WORK TO TRIGGER IN AN EVALUATION ITERATION
MAINTAINING AND ANALYZING PROCESS CONTROL METADATA TO GUIDE PROCESS AUTOMATION
GUIDING PROCESS AUTOMATION BASED ON PREDICTED WORK
EXAMPLE END-TO-END EXECUTION SERVICE
PROACTIVE ERROR MITIGATION
ADAPTIVELY PARALLEL EXECUTION
EXAMPLE SYSTEM EFFICIENCIES
EXAMPLE PROCESS MANAGEMENT SYSTEM ARCHITECTURE
CONSUMING WORKLOAD METADATA BY LARGE LANGUAGE MODELS
ARTIFICIALLY INTELLIGENT AGENTS FOR MONITORING AND PERFORMING ACTIVITIES
AGENTIC ARCHITECTURE FOR ORCHESTRATING ASYNCHRONOUS ACTIVITIES TO KEEP DATA UP-TO-DATE AT AN ADAPTIVELY VARIABLE TYPE-SPECIFIC CADENCE BASED ON PROCESS CONTROL METADATA
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### WORKFLOWS AND BUSINESS PROCESS AUTOMATION

Business application and data platform users often look to have most current/“fresh” data for insights and decision making in their business operations reporting. In enterprise systems like Oracle Fusion Applications, processing of large volumes of data may be done

continuously using Enterprise Scheduler Service (ESS) Jobs. ESS jobs are used to automate, schedule, and manage processes that need to be executed periodically or triggered under specific conditions with the intent to streamline business operations and reduce manual intervention. They are used for a wide range of tasks, from generating reports and automating financial processes to managing system maintenance and handling order processing. ESS jobs and other automated processes or flows can trigger PL/SQL scripts, workflows, Java-based tasks, shell scripts, and/or external application calls. Many implementations of Fusion Application, Enterprise Resource Planning (ERP), or other enterprise-grade business processes and batch jobs may depend on system knowledge and creation of explicit schedules, which can cause sub-optimal scheduling, in terms of sequence and frequency, by System Implementers. Application and platform user environments currently have one or more of the following scenarios:
Jobs, such as ESS jobs, which customers tend to run frequently.
Jobs, such as ESS jobs, that run multiple times without any performing any operations.
Jobs, such as ESS jobs, which are scheduled infrequently.

These scenarios result in poor application service health and fragile and cumbersome business process execution. When scheduled jobs are executed by the system, professional users may be looped in to manually intervene in the business process to hunt for exceptions, resolve errors and resubmit the jobs.

Additionally, application and platform users are not provided with business controls, tolerances, and thresholds to help streamline the import and processing of data and minimize manual intervention. The users may bring external data from multiple sources, and some is ingested using solutions like REST interfaces or Product APIs into the ERP system in a real-time fashion without cumbersome Information Technology (IT) admin interactions with file servers and intermediate interface entities that require heavy manual intervention. There may be a lack of operational instrumentation in ERP business processes that can provide ability for process mining in getting various business insights, monitoring, functional observability into the lifecycle, status, exceptions, throughput of these processes. With all batch job executions, technical status tracking is possible with the enterprise scheduler service user interface (UI), but technical status tracking alone might not provide sufficient control and analysis of process automation.

### RESOURCE UTILIZATION FROM RUNNING PROCESSES ASYNCHRONOUSLY

A process management system may run processes asynchronously with source data updates. One approach of asynchronous process management is performance according to a rigid schedule. In this approach, the process may be triggered during a frequency or period, and the process may wait for another iteration of execution until the period of time has passed. In one example, after collecting data for a week, a customer may have 70 schedules that are scheduled to be run every 5 minutes based on business unit and a source parameter combination, even though data is loaded for accounts receivable invoices 6 times in a week. An import job may run 141,120 times a week, but, in the example, the import job actually process data only 29 times. That leaves 141,091 times that the import job ran as a no-op (no operation performed) in a week. In the example, an average no-op may take 4.1 seconds to perform, resulting in a significant amount of used computing resources without any substantive changes to the data or system. That results in approximately 160.7 computing hours per week spent running no-op processes when the values and state of the data would have otherwise been the same with or without these hours being spent.

On the other hand, large organizations have many data source processes that create or update parameters that are input to other processes, and it is difficult to predict exactly when these data source processes will run. These data source processes may create or update data that serves as a data source any time, even if in reality the data source processes perform these operations infrequently. In order to avoid missing critical updates for longer than 1 minute, 5 minutes, 10 minutes, 15 minutes, 30 minutes, 60 minutes, etc., organizations often set relatively short process run cycles to check whether or not there are operations to perform for processes that may be asynchronously downstream from the data source processes. In many examples, these downstream processes may not be triggered directly (for example, as a function call or sub-process) or immediately when the data source process creates or updates an input parameter. The direct and immediate operations of synchronous processes could further exponentially increase the number of no-operation processes and could interfere with system efficiency and usability to the point where updates are not possible or practical to make in finite time while running and completing all downstream processes for every update, as the updates are made. Asynchronous downstream processes alleviate this issue by running the downstream processes periodically rather than instantaneously. However, if the system has enough potential downstream processes, and if the periods for running these processes are relatively short to ensure up-to-date data quickly disseminates across the system, running all of these processes could result in the example inefficiencies above with hundreds or even thousands of hours of wasted computing time per day, week, or month due to no operation processes running even though there is nothing for the process to work on.

Although source datasets may be updated tens, hundreds, or thousands of times, downstream processes depending on those source datasets may accommodate batches of changes made during those updates in a single or fewer runs. In this manner, running the downstream processes asynchronously reduces the amount of computing operations performed at the potential cost of data being stale for certain times between the asynchronous process run and source process completion.

Although asynchronous processes save resources by potentially reducing the number of times a process runs over a short period of time, making the asynchronous run periods longer (e.g., extending a process that runs every 5 minutes to run every 15 minutes instead) results in harming the organizations by causing up to a new amount of delay (10 extra minutes, in the example) in utilizing the data by downstream processes. Due to this delay, data written or consumed as a result of the downstream processes may be updated later than expected for practical purposes for the organization. For example, if an organization was attempting to show employees how many awards they have received in a user interface, the user interface might not be updated until 15 minutes or more after the employee has been notified that an award has been granted. This delay could cause confusion, particularly if the awarded employee raises additional questions and follow-ups regarding missing awards during those 15 minutes. As another example, an account limit, other account restrictions, or alerts may be updated based on spending activity, and delays in updating the account limit, other account restrictions, or alerts could allow the account holder to exceed limits, restrictions, or alert thresholds before such limits, restrictions, or thresholds have been put in place or realized. In this example, an acceptable latency threshold of even less than a minute (e.g., 10, 15, or 30 seconds) may be configured by setting asynchronous processes to run even more frequently.

Also, for a given process, making the process asynchronous may increase the number of times the process runs. For example, a source dataset updated a few times per week may be monitored by a downstream process that runs every 5 minutes. In this example, the downstream process runs 2016 times per week in asynchronous mode when the process would have only run a few times per week in synchronous mode. Despite this inefficiency, many practical use cases still push downstream processes to be asynchronous to avoid a user-perceived delay or application latency in performing critical operations that result in updates to source data that would otherwise be consumed by the downstream processes. For example, a source process may take 5 minutes to run if the source process was synchronously checked by 80 downstream processes before completion, and users are generally not tolerant of such high latency from an application. In an asynchronous scenario, the source process may take millisecond(s) to run, with the downstream processes running later at scheduled times to see what other data should be changed based on changes to the source data.

For different datasets, organizations may have tolerances set for how stale the data is allowed to become. Some datasets managed by downstream processes may be allowed to be up to a day or a week behind the source data, and other datasets managed by downstream processes may be required to be up-to-date every minute, 5 minutes, 10 minutes, 15 minutes, etc., such that the downstream process may be run more or less frequently to keep the system up-to-date within the timeframe.

Running a no-op process consumes resources in addition to just computing time. Often, the no-op process includes an initialization of a data management session with a database such that the no-op process can retrieve and/or modify data if needed. The process logic of the no-op process may also be loaded, including not just the processes that are run but also processes that could be run depending on results retrieved during operation. For example, data retrieval node(s), data update node(s), data evaluation node(s), other action node(s), and specified condition(s) for each action node may be loaded so the system is capable of performing the process whether the process turns out to be a no-op process or a process that consumes and handles a large batch of new data.

The no-op process often does attempt to retrieve data on that data management session in one or more steps according to the action node(s) before determining that no operation is needed, and an appropriate amount of memory may be allocated in case there is data received as a result of those data retrieval steps. For example, the no-op process may attempt to retrieve data that satisfies a set of conditions and result in a no-op mode only when that attempt returns no results after searching all accessible data records for records that satisfy the given conditions. As another example, retrieved data may be further processed by action node(s) of the process before determining that no data update action is needed. This initialization of the data management session with the process logic, attempted retrieval of data, and/or further processing or analysis of the data consumes both processor time and allocated computing resources (memory) to the no-op process. Despite the resources spent, a no-op process may end up making no changes to the database or may update that the no-op process ran without updating target data designed to be managed by the no-op process based on source data.

In one embodiment, an execution service may check a high-level filter that determines whether there is pending potential work to be performed by a downstream process before calling the downstream process to perform the pending potential work. The execution service may prevent calls to the downstream process when there is no pending potential work for the downstream process to perform, and these prevented calls may save significant computing resources. Because the execution service applies high-level filters that may not account for a full logic of the downstream process, the downstream process may consume pending potential work only to determine that no operation is to be performed on the pending potential work. In this scenario, the execution service still contributes to the overall efficiency of the system by preventing calls to the downstream process when there is no pending potential work even if some of the pending potential work is not actually treated by the downstream process as actionable work. In other words, reducing a number of no-operations of the downstream process still achieves a higher efficiency in the system even if the downstream process still occasionally experiences no-operation executions.

### AUTOMATED HANDLING OF POTENTIAL WORK TO REDUCE WASTED CYCLES

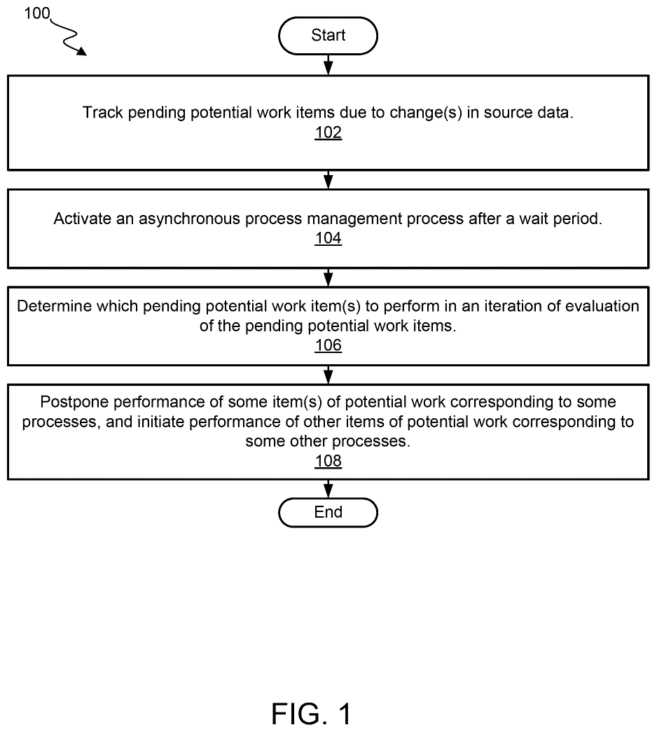

FIG. 1 illustrates a flow chart of an example process that efficiently manages asynchronous processes to reduce wasted cycles, for example, by avoiding a rigid compliance with process-specific schedules, while maintaining current data for insights and decision-making. In block 102, a process management system tracks pending potential work items due to one or more changes in source data. In block 104, the process management system activates an asynchronous process management process after a wait period. In block 106, the process management system then determines which pending potential work items to perform in an iteration of evaluation of the pending potential work items. The process control metadata includes stored limitations on a timing for performing individual processes. In block 108, the process management system postpones performance of some items of potential work corresponding to some processes and initiates performance of other items of potential work corresponding to some other processes based on the process control metadata. Initiating performance of a potential work item may include triggering a corresponding process to consume data based on the potential work item.

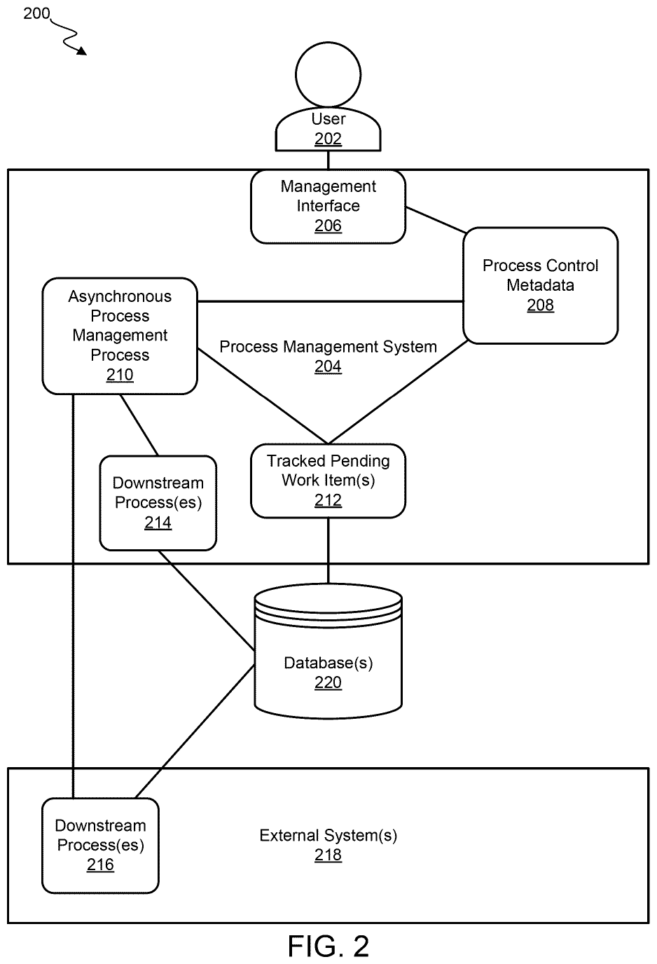

FIG. 2 illustrates a system diagram showing an example cloud infrastructure that efficiently manages asynchronous processes to reduce wasted cycles while maintaining current data for insights and decision-making. As shown, user 202 may interact with management interface 206 to enable process management system 204 and/or modify process control metadata 208. Process control metadata 208 is used by asynchronous process management process 210 in an evaluation iteration to determine, based also on tracked pending work item(s) 212 from source data changes, which downstream process(es) to trigger based on which pending work item(s). Asynchronous process management process 210 may trigger downstream process(es) 214 managed on the same system and/or downstream process(es) 216 managed on external system(s) 218, via exposed function calls or APIs or other techniques. Downstream process(es) 214 and/or 216 cause changes to database 220, which may further modify source data for other downstream process(es) 214 and/or 216 that may be handled by a later downstream process executed in the same evaluation iteration or in another evaluation iteration of waking up asynchronous process management process 210 to trigger downstream process(es) 214 and/or 216.

In one embodiment, business data processing is automated in an enterprise system allowing customers (e.g., application and/or platform users) to leverage up-to-date data for insights and decision-making eliminating user intervention, simplification of system integration, and optimizing system resources. A machine learning based framework continuously detects business object/entity lifecycle events streamed across the flows, such as procure to pay, order to cash, project management, acquire to retire assets, and record to report flows. Transaction data can be streamed from external sources as well as generated within the enterprise business system as day-to-day business activities occur.

The continuous execution framework may evaluate transaction events for appropriate enterprise structure contexts along with functional influencers, assess available system resources, evaluate job priority, consider thresholds to determine the appropriate processing unit, and autonomously progress data from one state to another. The framework may prioritize data processing sequences with consideration to operational calendar, and business process flows. The framework self-detects system resources to determine the approach for processing—parallel processing, immediate or deferred execution. This eliminates customer's reliance on manual intervention or predefined sub-optimal schedules to process data that may overburden the system. This invention accelerates the lifecycle of object state changes and eliminates idle time when objects are waiting for processing. Additionally, the framework will track the lifecycle of business data processing including exception management. This allows the system to self-learn a customer's approach for exception resolution or for data processing and apply it for future transaction processing.

In various embodiments, the Continuous Execution Service (CES) or execution service is a headless service to fast-track processing of data from various source systems in ERP Cloud or other source systems (for example, leveraging real-time feeds), use functional events on business objects to orchestrate the overall business process to transport the business object's data from a source system to a downstream process that changes data or performs an action in the system, resulting in a logical end state.

### DETERMINING WHICH PROCESSES HAVE PENDING POTENTIAL WORK TO PERFORM

With a variety of custom user-defined downstream processes, the process management system may determine which of those processes have pending potential work to perform based on what source data has changed since the downstream processes were last run. The process management system may maintain process execution control metadata that defines how frequently downstream processes should be running if there is work to perform, and may compare the process execution control metadata with pending potential work to perform to determine which pending potential work should be initiated for performance in a given evaluation iteration of the execution service. For example, the execution service may look at the pending work to determine which work would be late if postponed until a next evaluation iteration and which work could safely be postponed until the next evaluation iteration. The work that would be late if postponed may be used to trigger downstream processes that consume the source data that defines the work, and the work that may be safely postponed until the next evaluation iteration may be used to trigger downstream processes, if additional cycles are available, if database workload is below a threshold, and/or if database sessions or other resources consumed are below a threshold. Alternatively, if such resources are not available or at the discretion and depending on the implementation of the execution service, triggering of downstream processes that would not be late if postponed may be safely postponed until a next evaluation iteration, in which case a similar check may be performed and the work may be safely postponed again or used to trigger downstream processes at that time.

In one embodiment, each downstream process may be registered to provide metadata about what process may be performed, what are the parameters (fields that may change in value) that indicate work may need to be initiated for performance by the process, what criteria or conditions should be satisfied to indicate work may need to be initiated for performance by the process, and/or what conditions should be satisfied for the work to be tracked. For example, one process may trigger based on a new or updated invoice type for a record, and the process management system may, based on metadata indicating that invoice type is a field to be tracked, update a pending work data structure whenever a record's invoice type is created or updated. In another example, a downstream process may run depending on whether a contact in a particular group of a plurality of groups and a particular source of a plurality of sources has been created or updated, and the pending work may indicate whether a contact record potentially having that criteria has potentially been created or updated, based on tracked updates with field-specific data.

The metadata guides the process management system on which field updates to track as pending work, and the execution service may consume these field updates with reference to the process execution control metadata to determine which downstream processes should be triggered based on changes to different fields in different records. As the metadata is updated to indicate that different fields are relevant to different processes, the process management system may update which fields are tracked for ongoing transactions. The updated fields may be tracked as pending work, which may be consumed by downstream processes when triggered by the execution service.

### DETERMINING WHICH POTENTIAL WORK TO TRIGGER IN AN EVALUATION ITERATION

In one embodiment, the execution service may use the process execution control metadata to influence which downstream processes are triggered on different evaluation iterations of the execution service, and which pending work can be safely postponed until a later evaluation iteration. In this manner, the execution service may prioritize some downstream processes over another in a given evaluation iteration while still satisfying the conditions specified in the metadata. If additional database bandwidth is available, pending work that is staler but still within the metadata conditions may be prioritized by triggering downstream processes associated with this work ahead of or instead of other pending work that is less stale but still within the metadata conditions.

In one embodiment, the process execution control metadata may define cumulative thresholds that are used to prioritize work that, collectively, satisfies the cumulative threshold without prioritizing work that does not collectively satisfy any thresholds. For example, the thresholds may indicate that a certain dollar value or sales amount of deals not yet processed by downstream processes should be pushed forward to downstream processes even if the pending work is not otherwise “due” according to the maximum asynchronous wait period of downstream processes. In this manner, prioritized work may be handled asynchronously even earlier than such work would have been handled if the downstream process was handling the work directly because the execution service is aware that the pending work has exceeded the threshold even if the timer for the end of the waiting period for the downstream process has not yet expired.

In one embodiment, even if multiple downstream processes are “due” for execution, an order of execution of the downstream processes within an evaluation iteration of the execution service may prioritize one of the downstream processes over another based on the metadata. The metadata may indicate a relative ordering or priority of the processes that should be executed assuming that all processes are satisfied, such that high priority processes stay up-to-date even if low-priority processes contribute spurts of high volumes of transactions to the pending work. The priority may be indicated as a number for each process, where higher or lower numbers receive priority over other processes, or based on an ordering of the processes in an influencers data structure, where earlier-listed influencers may receive priority over later-listed influencers, for example.

In contrast with independently executing asynchronous processes, processes controlled by the execution service may be executed such that expected efficiencies are realized in the order of execution. For example, a first process may be triggered based on updates to a first field of data in various records, and the first process may cause updates to a second field of data in various records. A second process may be triggered based on updates to the second field of data and cause updates to a third field of data in various records. If both processes are scheduled with a same frequency or overlapping frequency, independently executing the asynchronous processes may result in the second process being triggered before the first process, causing the second process to miss consuming the updates to the second field made by the first process. If both processes are executed in an order determined according to priority by the execution service, the first process may consistently be executed before the second process such that additional updates to the second field by the first process are consistently handled by the second process resulting in a more complete set of data including updated third fields across a larger number of records than if the second process had run before the first process.

By restricting ordering, the execution service can also avoid race conditions where competing processes are attempting to update a same field in different ways, resulting in a more consistent and deterministic system state at any given time. In one embodiment, the influencers metadata includes information that indicates which other processes should not run concurrently with a given process, and the execution service may enforce a lack of concurrency between concurrency-restricted processes. On the other hand, the execution service may concurrently execute, in parallel threads and potentially different database sessions, different processes that have different priorities but do not have any concurrency restrictions.

In one embodiment, the execution service wakes to perform an iteration of evaluation of which processes to trigger and which processes not to trigger during the iteration. The execution service first determines if there is any pending work applicable to a process that has not yet been processed. Then, the execution service determines if there are any influencers or other process execution control metadata that indicates whether some or all of the work should be postponed to a next iteration or some or all of the work should be handled in the current iteration. The process execution control metadata may be configurable by a user, via an influencer configuration interface, to specify conditions for determining when to trigger various processes. Regardless of whether the conditions were specially configured or determined from the process itself, the execution service complies with the frequency constraints, execution conditions, batch limitations (e.g., how many records can be handled by each instance of a downstream process and whether to trigger downstream processes when aggregate data meets or exceeds a threshold), and other logic embedded in an influencer data structure to determine when to trigger downstream processes and to ensure that downstream processes run as frequently as requested but without running the downstream processes when there is no pending potential work for the downstream processes to perform.

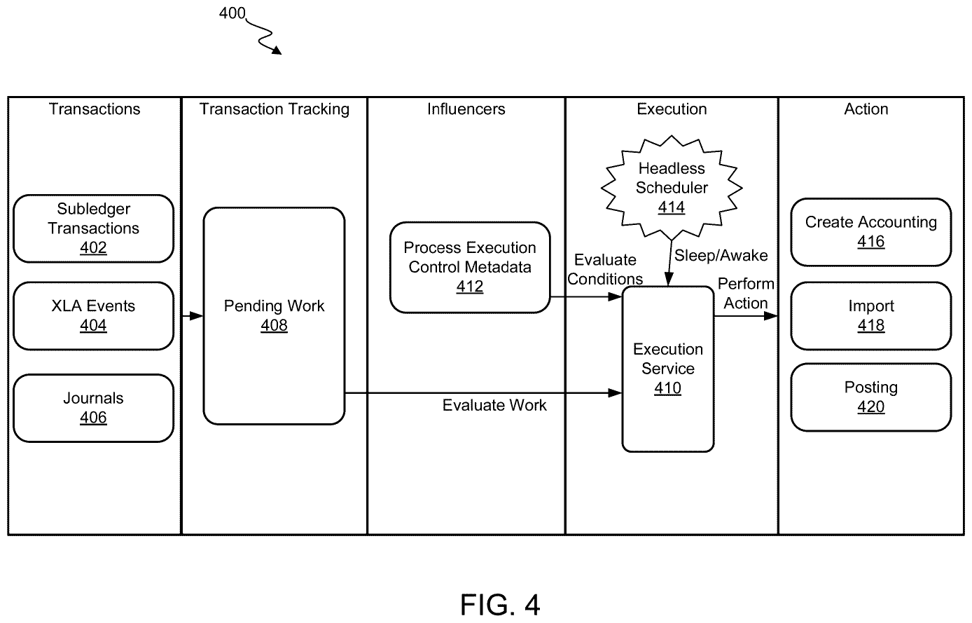

An example process management system architecture is shown in FIG. 4. As shown, transactions such as subledger transactions 402, XLA events 404, journals 406, and other changes to source data may occur and be ingested to the process management system. The transactions may be tracked, and pending work 408 may be asynchronously or synchronously evaluated by an execution service 410 to determine whether process execution is needed for different downstream processes. For example, downstream actions 416, 418, and/or 420 may create accounting or other records, import data, and/or post data to other systems. The execution service 410 may evaluate influencers specified as conditions in process execution control metadata 412 along with the pending work 408 done or being done since the last time execution service 410 ran to determine whether any downstream processes should be triggered and, if so, which ones. If executing asynchronously, the execution service 410 may wake periodically via headless scheduler 414 according to a shortest period of the downstream processes or another configurable period. The execution service 410 triggers selected downstream processes and sleeps again until a next asynchronous period when the execution service becomes active again. For any downstream processes that would have been triggered but which have no pending work or new source data to operate on, those downstream processes may be saved from running by the execution service. In other words, the downstream processes may be skipped even if they would have otherwise run during that period if there is no pending work detected for the downstream process to handle. Pending work for all downstream processes may be checked together by a single process, saving resources otherwise consumed in parallel by many different downstream processes overlapping at the same asynchronous periods. Any downstream processes with pending work or pending potential work that are due to run may be run accordingly by the execution service. Downstream processes may be “due to run” if skipping the downstream process and waiting until the next asynchronous period of the execution service would result in exceeding an asynchronous wait period, as configured for the downstream process, for any item of pending work.

In one embodiment, due to the efficiency of running a single execution service to check for pending work for a plurality of downstream processes (for example, tens, hundreds, thousands, or even tens or hundreds of thousands of processes that would otherwise be independently scheduled to run at various intervals or frequencies), the single execution service may be handled in a cloud services contract as vendor work rather than as customer work. In this manner, the customer may be charged for computing resources consumed by running downstream processes without being charged for computing resources consumed by running the single execution service. The single execution service may not need to be initialized each period but may instead be pre-initialized in a constantly running process that is slept and awoken at configurable intervals. As the execution service is not running in parallel with other execution services, the execution service may not be consuming significant memory or resources even if database resources, memory, or other specially configured or allocated resources are reserved for the execution service when it wakes.

In some embodiments, the processes differ based on which business units or subsets of data are involved, as different implementations may have divergent data management processes for hundreds of different business units. In these scenarios, an organization may have experienced no updates to a record type during a period of time but may, in scenarios that do not take advantage of the execution service, run hundreds of processes corresponding to each of the different business units and divergent implementations just to conclude for each one that there is no data to process. The execution service eliminates this significant inefficiency without requiring a full understanding of all of the sub-processes performed by the logic implemented for the different divergent downstream processes.

In a simplified example, a first downstream process or flow F₁ may have pending work when a contact from group 1 is created; a second flow F₂ may have pending work when a contact from group 2 is created; and a third flow F₃ may have pending work when a contact from group 3 is created. When no contacts are created during the period, the execution service may skip executing flows F₁, F₂, and F₃ during the evaluation iteration of the execution service, rather than having flows F₁, F₂, and F₃ each run independently to determine that there is no data to update for this period. In this example, even if a contact was created for a given group, such as group 2, the execution service may track for which groups contacts were created to determine which flows to run and which flows not to run based on metadata stored in association with the different flows.

The cloud vendor benefits from not having a plurality of no-op processes running simultaneously and competing for resources while attempting to access the same datasets, and the customer benefits from having lower overall compute and resource consumption expenses in the cloud infrastructure environment. Tracking the resource consumption of downstream processes separately from the execution service enables this significant additional benefit.

The execution service may exist in the cloud infrastructure and need not be initialized or allocated for each separate downstream process. The database resources used by the execution service may be “headless” in the sense that the database resources do not require a user interface or environment to be loaded or available to support the execution service and/or that the execution service does not need a separate database session to manage metadata specific to the execution service within the database. In this manner, the execution may save valuable database session resources, as a finite number of database sessions (e.g., 30-50, 50-100, etc.) are available in the database, with amounts depending on the implementation. The execution service does not run inside an application-scheduled process container but instead runs above a plurality of application-scheduled processes to control when the processes are triggered or not.

In contrast, if downstream processes were concurrently executed at each iteration, the concurrently executing downstream processes may each consume separate database sessions to concurrently execute transactions against the database. These heavyweight concurrent asynchronous processes may tie up database resources that could otherwise be used ongoing synchronous work that is being executed separately from the scheduled asynchronous work.

The execution service may run checks using a direct connection with the metadata about resources that have changed or not, indicating pending work to be performed or not, and the execution service may directly call downstream processes. Instead of running asynchronously according to a fixed schedule, these downstream processes may be called by the execution service and, in one embodiment, run only when they are called by the execution service after evaluating the metadata.

In one embodiment, the execution service manages candidate processes for which automation may be triggered. The execution service reduces candidate processes to a subset of candidate processes for which there are pending work items to complete. The subset may exclude other candidate processes for which there are no pending work items to complete. The execution service may further determine that available resources for execution, such as database sessions for performing changes, do not accommodate all of the processes for which there are pending work items to complete. Based on process control metadata, the execution service may select one subset of work item(s) corresponding to one subset of process(es) for which to trigger execution and another subset of work item(s) corresponding to another subset of process(es) for which to postpone triggering execution. Postponing performance of the other subset of work item(s) corresponding to the other process(es) may be done in response to determining that the current system resources do not accommodate triggering all of the downstream processes in a current iteration of the execution service.

In various embodiments, each downstream process that is called by the execution service may be stored in association with their own process-specific schedule native to a scheduling system, the process-specific schedule having a fixed period in which the process runs. The process-specific schedule or an iteration thereof may be marked as completed or disabled when the execution service handles work items on behalf of the downstream process. If there were no pending work items to trigger for the downstream process, the process or iteration may be marked as completed without initiating the downstream process at all. If pending work was triggered for the downstream process, the pending work items triggered by the execution service may count as completion of the downstream process even though the downstream process may not have been executed according its process-specific schedule that is native to the scheduling system, and even if the fixed period for the process-specific schedule had not yet passed since a prior iteration of the downstream process.

In one embodiment, the execution service is a lightweight headless scheduler service (such as Quartz, Cron, Spring, JobRunr, or any other headless scheduler service) that uses a job scheduler (such as a native database job scheduler, native platform scheduler, or any other job scheduler) that operates periodically independently of client-specific scheduled processes. The scheduler service may schedule jobs using triggers based on execution times or intervals, and the scheduler service may persist job and trigger information in the database. The execution service may connect with the metadata using an API, such as a JavaScript API, which may be managed separately from database sessions since the metadata may be maintained specifically for the execution service. Managing the metadata may not give the execution service the ability to change other data in the database or in other systems, and, in one embodiment, a database session is consumed only when calling a downstream process to make potential changes to downstream datasets in the database or in other systems.

### MAINTAINING AND ANALYZING PROCESS CONTROL METADATA TO GUIDE PROCESS AUTOMATION

In one embodiment, in order to update how frequently a process runs or under what condition a process runs, a user may update an influencer data structure via an influencer configuration interface rather than updating each process separately. In this manner, a set of selected processes may be concurrently updated to run more or less frequently according to user configuration preferences without selecting each process separately and updating how frequently the process is scheduled. The execution service then uses the influencer data structure to determine how frequently and under what conditions to execute individual processes covered in the influencer data structure.

Even without adjusting process frequencies, the execution service may automatically detect the process frequencies upon registration of the process with the execution service. The automatically detected process frequencies may be preserved if there is work to be performed, and additional executions of the process may be avoided if there is not work to be performed within a period covered by the process frequency.

In one embodiment, the execution service may detect that a set of data has a high number of changed records or changed values aggregated in the queue and trigger a downstream process that consumes the changed records or values to make updates even though a full wait period of the downstream process has not yet occurred. In addition to considering how many records or how much value has accumulated, the execution service may determine to execute a process ahead-of-time based on a low workload experienced during an evaluation iteration, to ensure that the queue of pending work is reduced for higher workload evaluation iterations that are predicted to occur in the future.

In one embodiment, a process management system causes display of a user interface for updating particular process control metadata for process(es) that may or may not be later triggered by pending work items. The process management system receives, via the user interface, input that specifies updated condition(s) for the process(es) and stores the updated condition(s) as part of the process control metadata in association with the corresponding process(es). The process management system may then select which process(es) to trigger and which process(es) to postpone, as well as optionally a priority or order of triggering the process(es) based on the updated condition(s) provided via the user interface.

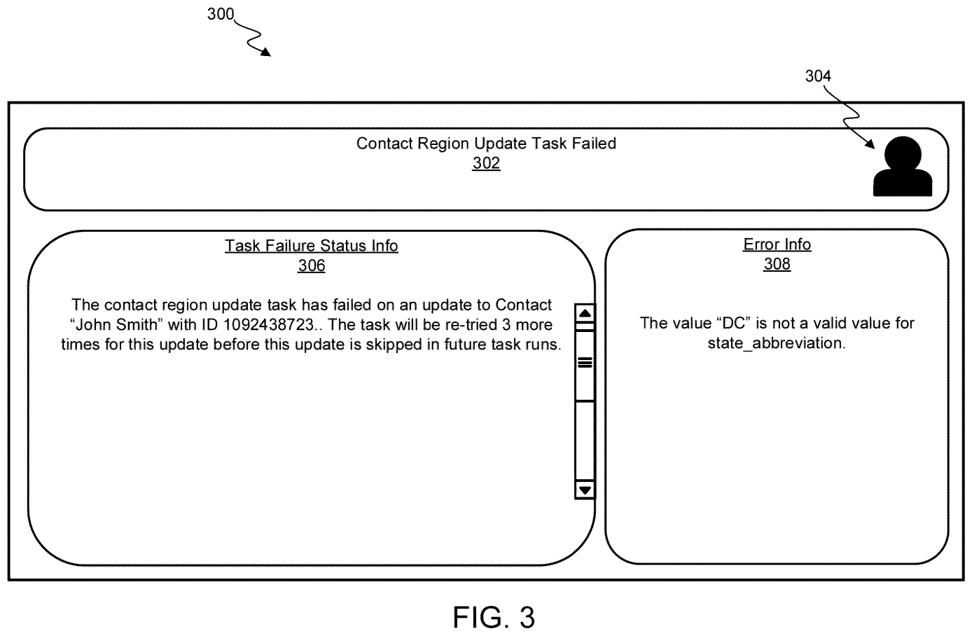

FIG. 3 illustrates a diagram of an example user interface 300 showing a notification about an automated process that is not completing according to guidance specified in influencer metadata. As shown, a header 302 indicates that a contact region update task has failed. Interface 300 may also include information about a user 304 who is authenticated and logged into the system to receive notification(s) about task status(es). Interface 300 includes task failure status info 306, which, in the example, states: “The contact region update task has failed on an update to Contact “John Smith” with ID 1092438723. The task will be re-tried 3 more times for this update before this update is skipped in future task runs.” Interface 300 also includes error info 308, which states “The value “DC” is not a valid value for state_abbreviation.”

In the same or another embodiment, the process management system accesses a process-native scheduling registry of individual process(es). The individual process(es) may initially have process-native scheduling enables. The process management system may disable the process-native scheduling for the process, assuming control of when the process is triggered. The process management system may also store, in the process control metadata, condition(s) for triggering the individual process(es) based on when the individual process(es) would have otherwise been triggered corresponding to the process-native scheduling. The process management system may later initiate performance of the corresponding individual process(es) based on the stored condition(s) for the corresponding process(es) in the process control metadata.

The process-native scheduling may inform when the process would have been run if work was available to run, but the process-native scheduling information may also inform of what inputs the process receives when the process runs. For example, the process may run on any changed records of a particular type, and the process management system may store information in the process control metadata, indicating that the process runs on changed records of the particular type. Later, the process control metadata may be used to skip running corresponding process(es) when records of the particular type have not changed since a last iteration of the execution service.

### GUIDING PROCESS AUTOMATION BASED ON PREDICTED WORK

In various embodiments, the execution service may model pending work for each of the processes over time, optionally with seasonality (hours, shifts, days, weeks, months, and/or years). The model of pending work may be used to predict which processes spike in pending work at which times, and the execution service may proactively clear a pending work queue in anticipation of predicted spikes in pending work. For example, if pending work for a particular process usually spikes on a Thursday with work items beyond an amount of work items that can be handled by an individual run or iteration of the particular process, the particular process may be triggered before the spike or as the spike is hitting to keep the particular process clear of work items as the work items build up at the normal day and time.

In one embodiment, a predictive model may be trained based on which processes exceeded an amount of work items that can be handled and when those processes exceeded a maximum number of work items that can be handled during an iteration. These overflows of work items can be treated as misses, with all other process runs treated as hits, to minimize a number of misses based on work item allocation to processes.

In one embodiment, a process management system predicts a work quantity for individual process(es) based at least in part on a historical work quantity for the individual process(es). Individual process(es) may be selected for execution or postponement based on the predicted work quantity and/or other factors.

### EXAMPLE END-TO-END EXECUTION SERVICE

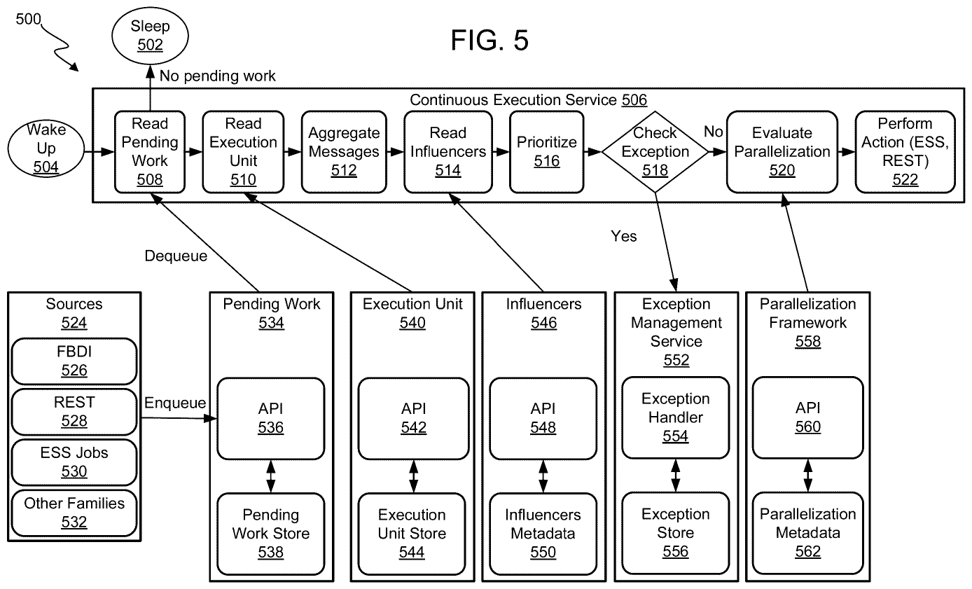

A more in-depth example of the execution service is shown in FIG. 5. In the example, a Continuous Execution Service 506 is invoked by a headless scheduler to wake up 504. This service 506 reads the pending work 508, execution unit 510, influencers metadata 514 for continuous execution, and prioritizes 516 pending work. When there is any pending work that matches the influencers, then the execution service initiates corresponding actions or processes, such as a flow, ESS job, or REST or other service call 522. Once work is completed for an iteration, continuous execution service 506 may sleep 502 until a next iteration.

Continuous execution service 506 reads pending work 508 from pending work logic 534, which includes API 536 to access pending work store 538, which enqueues work from sources 524, which may include FBDI 526, REST 528, ESS Jobs 530, or other families 532.

Continuous execution service 506 reads an execution unit 510 using execution unit logic 540, which includes an API 542 to access an execution unit store 544.

Continuous execution service 506 reads influencers 514 using influencers logic 546, which includes an API 548 to access influencers metadata 550.

Continuous Execution Service 506 may also check for exceptions 518 and/or evaluate parallelization 520. Exceptions are checked using exception management service 552, which includes an exception handler 554 to handle exceptions based on an exception handling history in exception store 556. Parallelization is evaluated using parallelization framework 558, which includes an API 560 for accessing parallelization metadata 562. Parallelization metadata 562 informs the parallelization framework 558 which processes are highly parallelizable together and which processes have dependencies or otherwise do not benefit from parallelization.

In a first phase, transactions gets populated into any of the sources as part of the business process. As the transactions are populated, pending potential work may build up based on transactions that modify tracked objects.

In a second phase, a headless scheduler wakes up at a defined interval and calls a Continuous Execution Service. The Continuous Execution Service a) reads sources to determine if data is present to be processed and populates a condensed data structure (shallow entity) for determining which jobs/processes have data to be processed. The execution service also b) reads data and groups the data based on seeded metadata of an ESS parameter to interface column association, and c) optionally populates the condensed data structure with total counts by grouped attributes.

If customers have defined influencers, the Continuous Execution Service reads the influencer metadata and determines if action needs to be initiated for performance or not.

In a next step, the execution service evaluates priorities based on the influencers and system resources availability to determine an order of processes to trigger and whether or not to postpone certain processes to a next iteration of the headless scheduler waking up.

The execution service then determines an execution unit and submits the request if there is a matching execution unit to the data present in the condensed data structure. For example, if there are condensed data structure records for journals and payables invoices, then the execution service will look for execution units to match the 2 jobs. If there is a scheduled job/execution unit present, the job will be submitted.

In one embodiment, the condensed data structure holds the total counts with ESS job id once the execution units are submitted. For example, if 2 execution units were determined for Import AutoInvoice (BU1 and Source 1, BU2 and Source 2) then 2 rows will be populated in the condensed data structure with the total counts for each of these execution units/ESS jobs submitted.

In one embodiment, once a job has been enabled and performance of the job has been initiated, existing ESS schedules for the enabled jobs in the current and/or next interval (e.g., 15 mins.) may be canceled to avoid duplicative performance of the job.

In various embodiments, current data maintained by an execution service may be used for automated or manual reports, insights, graphs, visualizations, predictions, or other forms of data consumption as delivered by applications or tools. These reports, insights, graphs, predictions, or other forms of data consumption may be informed by machine learning model(s) that learn from updated data to provide new predictions, notifications, or visualizations based on the updated data and scenarios applicable to historical data. These predictions, notifications, or visualizations may be delivered to different users or groups of users, depending on the data sets involved and the users subscribed to receive updates.

### PROACTIVE ERROR MITIGATION

In one embodiment, before initiating execution of the process, the execution service may check if there are exceptions for same or similar parameters or types of parameters. If there are exceptions, the execution service may skip the process and not initiate execution of the process. If there are no exceptions for same or similar prior parameters, the execution service may proceed to generate an execution unit for each group of data and submit a job for initiating performance of potential work reflected in each group of data.

In one embodiment, the execution service determines if a given item of pending work has triggered an exception in the past and, if so, de-prioritizes the pending work item or skips the pending work item based on the determination. Pending work items that have triggered errors may be flagged as having triggered an exception or other error, and additional data stored in association with the pending work item may indicate a next evaluation iteration, if any, in which the pending work item should be attempted and/or how many times the pending work item has experienced an error. In one embodiment, the execution service may notify an administrator or user associated with the process that is experiencing an error during the pending work item. For example, the user(s) to be notified may be determined based on a user or group of users stored in association with a flow to handle errors for the flow, optionally accounting for a region associated with the data causing the exception and corresponding region(s) of the user(s) to match user(s) with errors associated with their region(s).

A notification may indicate that the pending work item is being repeated at the next evaluation iteration but only for a certain number of encountered errors, skipped for a certain number of iterations, skipped for a certain amount of time, or skipped indefinitely until the error is fixed (for example, by the user). In this manner, the execution service may avoid wasting valuable cycles on handling processes that result in exceptions. In many scenarios, these processes may consume a large or even maximum amount of resources available to each process, and the over-consumption of resources may contribute to the exception. Re-executing these high-consuming processes over and over again may prevent other critical processes from running due to a lack of remaining resources, and skipping these high-consuming processes may allow the system to maintain a healthy state despite encountering unresolved exceptions.

In one embodiment, the execution service may learn that a process on a pending work item is likely to fail even though the process has never been attempted on the pending work item based on processes that have failed on pending work items sharing similar characteristics or data types as the pending work item. For example, if data having a particular data type, value range, or characteristic often results in failure, the execution service may de-prioritize execution of a work item involving the data and/or cancel or postpone execution of the work item. A user associated with the process may be notified that the work item is being postponed or canceled with an option to proceed with executing the work item. Feedback from the user may be received in response to the notification and may place the work item back into queue for execution or may confirm that the work item should be canceled.

In one embodiment, the execution service may use a machine learning model to learn the patterns of characteristics that likely result in exceptions or failures. The model may be supervised or unsupervised. In an unsupervised embodiment, patterns of characteristics of work items experiencing errors are detected and used to find new work items having similar patterns. In a supervised embodiment, feedback from a user on whether a work item should be canceled or postponed due to the work item likely causing an error may be used to identify other work items that should be canceled or postponed.

In one embodiment, a process management system removes an item of pending potential work from the pending potential work items when the item or information about the item is sent to a corresponding process for execution or handling. The process management system may detect an error in executing an item of pending potential work by an individual process and, based on the error, re-add the item to the pending work items. In a next iteration of running the execution service after a wait period has passed since sending the item to the corresponding process for execution, since receiving the error, and/or since re-adding the item to the queue, the process management system may re-evaluate the item of pending potential work to determine if the item is ready to use in re-attempting initiation of the corresponding process to consume the item.

In another embodiment, the process management system detects an error in executing the item of pending potential work by a corresponding process, and, in response to the error, marks the item as erroneous. The process management system may then trigger a notification to user(s) or group(s) of user(s) stored in association with the corresponding process, such as user(s) listed as owner(s) or creator(s) of the corresponding process. The notification may indicate that the item of pending potential work encountered the error and will be skipped in at least a next iteration of running the execution service. Then, in a next iteration of the execution service that occurs after a wait period, the item may be efficiently skipped without encumbering the execution service with re-running items that are likely to fail again.

### ADAPTIVELY PARALLEL EXECUTION

In one embodiment, the execution service automatically adjusts parallelization based on data volume and/or system resources availability. The number of parallel threads may be automatically adjusted based on available system resources and/or number of transactions to be processed. In one embodiment, a number of parallel threads may be fixed such as 10 or 20 parallel threads that may be executed at a time. In this example, if there are 100,000 records to be processed and 10 threads to handle the records in parallel, the 100,000 records may be broken up by the process management system so that 10,000 records are handled by each thread.

In another embodiment, the number of parallel threads may be adjusted based on a number of available system resources and number of transactions to be processed. In this example, if there are 30 database sessions available and 100,000 records to be processed, the process management system may break up the 100,000 records into a subset of the resources available, such as 20, 25, or 30 out of the 30 available sessions (leaving some available sessions for synchronous work to be performed, such as handling user requests), and process the records on the subset of resources (for example, 25 threads each handling 4,000 records). The subset of resources may change as the total amount of available resources increases or decreases.

The subset of resources used may also account for a seasonality (variance by time of day, shift, week, month, or year) of the amount of database resources used for synchronous work and determine how many database resources to leave available for synchronous work based on the seasonal patterns.

In one embodiment, a process management system automatically adjusts a number of parallel threads for initiating processes by the execution service based at least in part on an amount of system resources for supporting both active user transactions and the processes initiated by the execution service. The number of parallel threads may be inversely proportional to a particular amount of system resources determined to be supporting the active user transactions. For example, as the particular amount of system resources used for active user transactions goes up, the number of parallel threads may decrease; as the particular amount of system resources used for active user transactions goes down, the number of parallel threads may increase. An overall number of threads in the system may also fluctuate, impacting a number of available threads even as the particular amount of system resources used for active transactions goes up. Various other factors may also impact how many threads are allocated for use by the execution service to initiate downstream processes.

### EXAMPLE SYSTEM EFFICIENCIES

In various embodiments, various advantages or system efficiencies may be realized, including any zero, one, or combination of the following:
Reduced overall ESS Load by reducing need for jobs to be scheduled or manually run by customer. In various embodiments, jobs may be executed only when there is data to process.
Reduced manual effort by proactively detecting and targeting what can be processed without user interaction or reliance on a schedule.
Allows customers to control/configure/switch on or off the automation by defining business rules and thresholds. For example, a configuration setting may state that invoices above a certain amount for a specific supplier can only be validated and accounted immediately (e.g., immediately reviewed and approved by an assigned reviewer) without being automatically pushed. In another embodiment, only certain business units may implement automated processing with other business units implementing manual processing.
Allows customers to review/monitor automated activities that were previously manually controlled so that the customer has visibility into what is being processed ‘behind the scenes’. In one example, a notification of what has been processed is provided to customers with links to output of the automated processing. In the same or another embodiment, an inventory of what data/jobs/source objects/inputs were processed, when they were processed, and/or a status (success/warning) of the processing may be provided in a notification.
The lifecycle of events may be tracked for future improvements. For example, the process management system may detect that a particular customer usually imports Payables invoices every Friday at 5 pm CET and then manually validates the invoices at 12 pm the following Monday. The regular pattern of manual validation may be detected and queued up for user review for potential automation.

### EXAMPLE PROCESS MANAGEMENT SYSTEM ARCHITECTURE

In various examples, the process management system has different components in place based on target functionality of different implementations. Example components include:

### Headless Scheduler

Maintenance stream is used to schedule a headless scheduler service for continuous execution. The default schedule may be 15 mins. or more or less, updatable by customers using a profile option.

### Continuous Execution Service

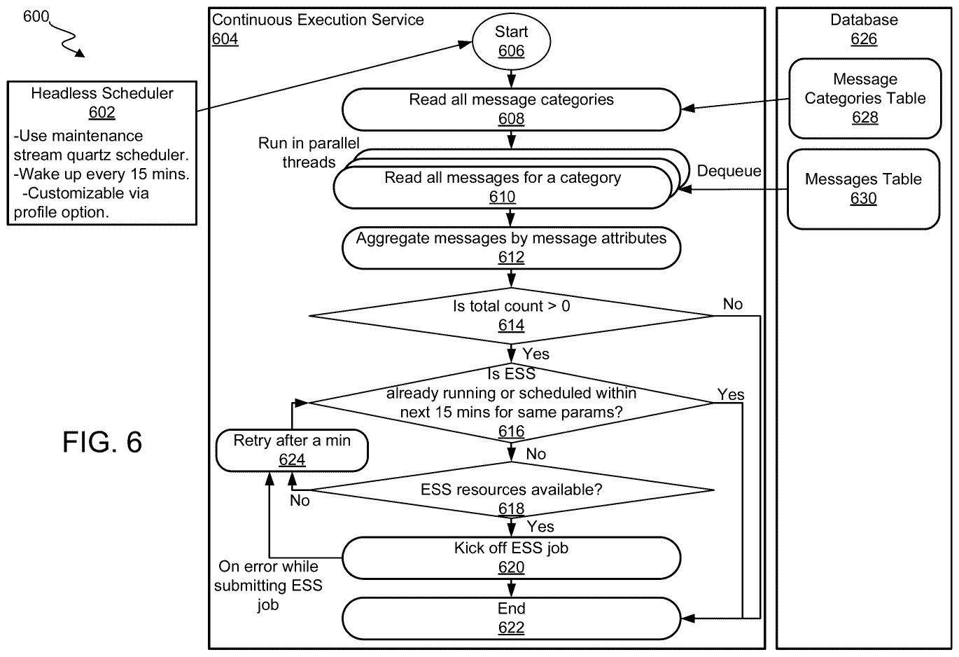

A flow chart showing an example continuous execution service process is provided in FIG. 6. In the embodiment shown of FIG. 6, a headless scheduler process 602 may wake up every 5, 10, 15, 20, 30, or 60 minutes (or any other main interval of time consistent with the implementation and metadata specified for downstream processes) to perform an iteration of evaluating metadata to determine which downstream processes to trigger. In the example, the scheduler process 602 wakes continuous execution service 604 to start 606 with reading all message categories 608 or all processes that are enabled for continuous execution and management by the execution service as determined from message categories table 628. For each process that is enabled for management by the execution service (all messages for a category 610), pending work may be dequeued from a messages table 630 to determine what pending work is available to be performed for each of the processes. For example, the execution service may execute a select statement against a table to retrieve records that were updated since a last evaluation iteration of the execution service, or records that were updated but have not yet been marked as processed by the execution service even if they were updated prior to the last evaluation iteration of the execution service 604.

Messages reflecting pending work that was not processed in a given evaluation iteration may be sent back to the messages table 630 for processing at a next evaluation iteration, with increased priority due to an increase in staleness of the unhandled messages even if the staleness is still within a threshold period of time specified in the influencers metadata.

In one embodiment, the messages table 630 of FIG. 6 may be populated based on events that were raised due to updates of fields or record types that have been flagged for tracking by the metadata. The events may be raised based on fields or record types indicated in the metadata, and/or condition(s) specified in the metadata that determine whether updated data counts as pending work or not for given process(es). The events may populate the messages table 630 with only those messages that are relevant to the execution service 604. The events may be executed synchronously or may be otherwise enqueued and dequeued at a finer-grained interval than the execution service iterations, thereby ensuring that the pending work table is prepared or efficiently maintained prior to the execution service 604 waking up.

In one embodiment, events may be populated synchronously for high-level metrics such as whether a contact was created and may be asynchronously filled in with lower-level metrics such as for which groups contacts were created and/or from which sources new contacts were received if the downstream processes trigger depending on the lower-level metrics. The asynchronous enrichment of event data may occur at the finer-grained interval such that data is enriched when the execution service 604 wakes, or may be performed during the evaluation iteration after the execution service 604 wakes.

In yet another embodiment, the messages table 630 may be a view of the underlying data sources, and the view may account for whether or not the data sources have been updated in a given period of time. The database 626 may materialize the view into the view's reduced and compacted form even prior to the iteration of the execution service, in which case the materialized view may be loaded as a whole, in the view's previously reduced and compacted form, by the execution service 604 without complex data processing.

The pending work to be executed may then be aggregated 612 by attributes, such as changes to particular fields or creations of or updates to certain types of records. If there are aggregate conditions defined in the metadata, the aggregated pending work may be evaluated to determine whether any aggregate conditions are satisfied. For example, if the metadata specifies that a process is to be triggered when 1000 records of that type are in the queue, then the process may be triggered as long as there are over 1000 records of that type in the aggregate pending work. If the total count is not greater than zero as determined in step 614, then downstream processes that would have been triggered for that pending work may be postponed to run until a next iteration of evaluation by the execution service.

If the total count is greater than zero as determined in step 614, then a check may be performed for whether there are any ESS or other process execution resources available in step 616, such as whether there are any database sessions or other database resources available for use to execute a downstream process. If not, the downstream process may be postponed in step 624 for a sub-interval (for example, a minute, or another interval less than the main interval of, for example, 15 minutes) to be tried again. If the process execution resources are available, a downstream process may be executed using the available process execution resources in step 620. Executing the downstream process may involve initiating a data management session, loading logic of the downstream process, and performing one or more actions defined by the logic to retrieve data and/or update data according to the logic.

If an ESS job with same or similar parameters is already running, the Continuous Execution Service may skip submitting another ESS job. Process concludes at step 622 until headless scheduler 602 re-awakens continuous execution service 604.

If there is an error while submitting ESS job (server down, connection failure etc.):
the Continuous Execution Service may retry after 1 min. or any other period of time shorter than the execution service wake period, for example.
If there is still an error submitting an ESS job after 5 (or N) retries, requeue the messages to the condensed data structure and send a notification to a role specified for that message category.
Also send an alert to a system admin of the error(s).

If there are no ESS slots or a smaller number of slots available, the Continuous Execution Service will retry after 1 min. If still not able to submit successfully after 5 retries, requeue the messages to the condensed data structure and the process will be handled on a next wake up iteration of the execution service.

If there is functional error in processing or only processed partial data, the processing ESS job will need to repopulate the condensed data structure when loading the interface table for reprocessing. For example, 40 of 100 records may fail in Import Journals. Once the user has corrected/provided the missing information in error correction UI/ADFdi, then the API that populates the corrected data to interface may also populate summary counts in the condensed data structure.

If the continuous Execution service dequeued messages and kicked off the ESS job, but the ESS job got canceled or killed, the message may be requeue using the following approach:
ESS request id is captured in the messages. When the execution service wakes up the next iteration, the execution service will check dequeued messages request status. If a request is cancelled or killed, then the execution service may requeue the message. The execution service may have a limit on retries and may send an alert to a Sys Admin after “N” tries and/or a time limit is reached.

To cancel Scheduled ESS Jobs, an elevated user such as FUSION_APPS_FIN_ESS_APPID may be used to cancel already scheduled jobs. New FND grants for object ESS_REQUEST_HISTORY and privilege ESS_REQUEST_ADMIN may be assigned to a user or application ID such as FUSION_APPS_FIN_ESS_APPID.

### Influencer Model

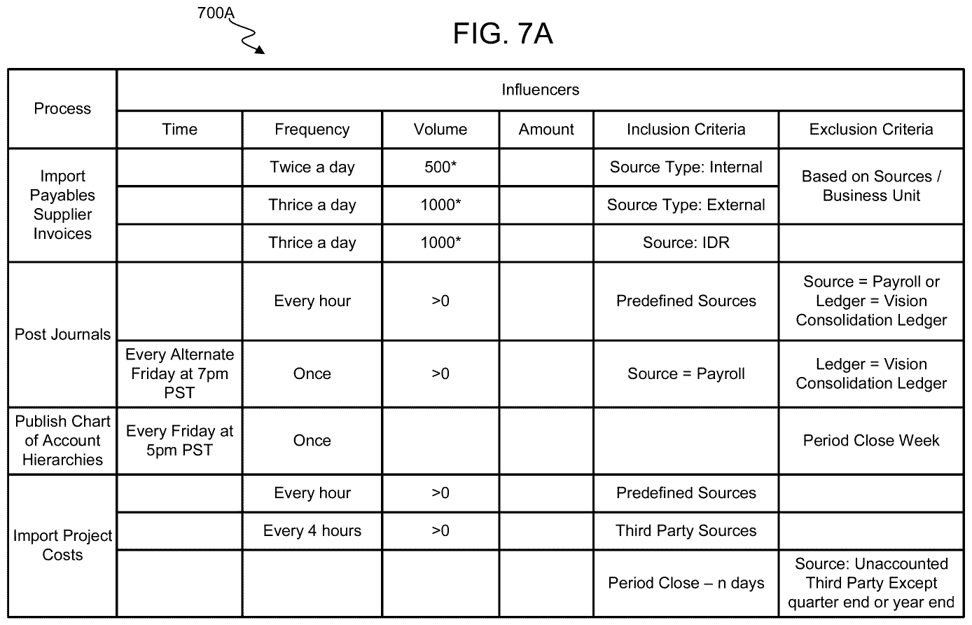

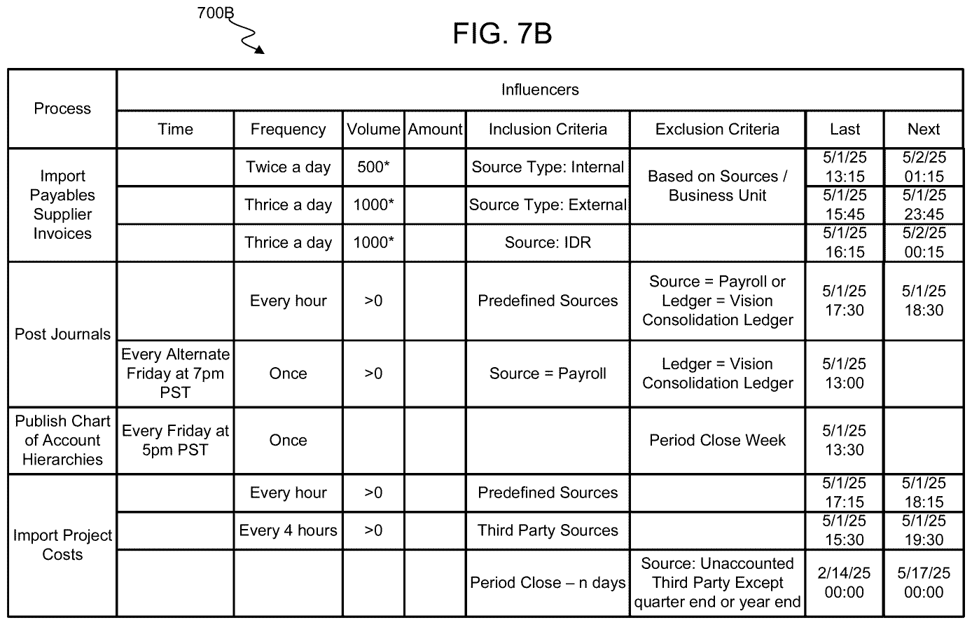

FIG. 7 shows an example table 700A storing influencer metadata for different processes. As shown, the metadata indicates which process is being managed, a specific time that the process must occur, a frequency by which the process should be triggered if there is work to be performed, a volume of records that should trigger the process, an amount of a field (e.g., aggregate dollar amount of sales) that should trigger the process, inclusion criteria for determining which changes or records should be included as pending work, and/or exclusion criteria for determining which changes or records should not be included as pending work.

In various examples, influencer attributes may come from 2 places:
A set of fixed attributes captured in lookup such as CURRENT_DATE, CURRENT_TIME, CURRENT_DAY, FREQUENCY, VOLUME, AMOUNT etc.
A set of attributes based on each job, which, for example, may be captured in FUN_CONT_EXEC_PROCESSES metadata. For example, Business Unit (BU), Ledger, Source etc.

Conditions specified in condition column may be evaluated with “AND” and/or any other logic specified in the condition column.

Conditions from multiple rows will be evaluated with “OR” or any other logic specified. In one example, conditions are evaluated based on type (exclusions first then inclusions) and processing order specified. If an execution unit satisfies a first condition, the execution service may submit a job for that execution unit. In this embodiment, further conditions might not be evaluated.

In various embodiments, the process management system ensures that there is no duplicate processing order.

In one embodiment, the execution service may be enabled by opting in to the execution service in an application or user session, where the opt-in may be one of the following values: OBSERVANT, ENABLED, or DISABLED OBSERVANT.

In observant mode, messages will be enqueued and dequeued, but Continuous Execution Service will not perform the action. The process management system may log details in metrics that indicate how many resources could otherwise be saved in continuous execution mode.

In enabled mode, messages may be enqueued and dequeued, and Continuous Execution Service may initiate performance of the actions.

In disabled mode, which may be default, messages may not be enqueued, and continuous execution service may not be scheduled.

### CONSUMING WORKLOAD METADATA BY LARGE LANGUAGE MODELS

In various embodiments, large language models may be used to determine work items to add to pending work, consume, arrange, annotate, or analyze pending work items, process control metadata, workload execution characteristics, workload execution history, and/or other workload metadata to understand impacts of adjusting type-specific workload cadences. The process control metadata may include any metadata that may guide timing, criticality, or other process performance considerations or influencers of how or how frequently to execute work items.

In one example, a configuration command may be provided to a natural language processing service in connection with a client to select a particular large language model for use with the natural language of given requests from the client. For example, the “openai” large language model provider may be chosen with named credentials. The model used may be, for example, gpt-3.5-turbo. Other example providers include, but are not limited to, Cohere, Azure AI, Google PaLM 2, Llama 3, DeepSeek, etc. In various other examples, default credentials may be used by the natural language processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a structured set of data along with a request for the large language model to analyze the structured set of data and order the structured set of data, make a selection from the structured set of data, filter the structured set of data, or match the structured set of data to another structured set of data. The structured set(s) of data referenced in the prompt may be formatted in a hierarchical format, such as JSON, XML, or another structured and delimited format that distinguishes between members at different levels of the hierarchy. The prompt may also specify a format for providing the reply, through example valid responses to example requests, and/or through explicit description of the requested format (e.g., by specifying a schema of the response format).

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any. If the LLM reply includes a data structure consumable by the application, the validation may include verifying that the data structure conforms to a schema or set of structured instructions exposed by the application through an API.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{“and”}” or “[“and”]” in the response. The values may be embedded in the delimiters and extracted from the embedded structure to determine values predicted by the LLM. The consumable JSON object may be separated from a remainder of the response for consumption by the application to create an executable structure to trigger application functionality.

### ARTIFICIALLY INTELLIGENT AGENTS FOR MONITORING AND PERFORMING ACTIVITIES

Clients may interact with large language model(s) using an agentic architecture. For example, different agents may serve as different clients to large language model(s) for the purpose of performing different activities. The different agents may use different prompt templates, pull in different sets of data to the prompt (e.g., via retrieval augmented generation from datasets relevant to the agent), and/or use different tools to process data before or after prompting the large language model.

Various aspects of determining work items to add to pending work, consuming, arranging, annotating, or analyzing pending work items, process control metadata (e.g., policies for when, how frequently, or otherwise how much or to what extent processes should be executed and/or a relative importance between processes), workload execution characteristics, workload execution history, and/or other workload metadata to understand impacts of adjusting type-specific workload cadences, generating and/or evaluating process control metadata, and/or selecting from candidate items of pending work for execution may be performed by artificially intelligent (AI) agents that use large language model(s) to enrich understanding and performance. Each AI agent may perform one or more of the listed tasks and/or other process management tasks. For example, one or more AI agents may be tasked with analyzing pending work, generating and/or evaluating process control metadata, and/or selecting from candidate items of pending work for execution. The AI agent(s) may be trained to perform specific tasks with regards to analyzing pending work, generating and/or evaluating process control metadata, and/or selecting from candidate items of pending work for execution, and such tasks may include generating a prompt to a large language model tailored to functionality supported by the agent or performing tasks of interpreting data in support of functionality specific to the agent. In a particular example, different AI agents are tasked with analyzing pending work than those that are tasked with generating and/or evaluating process control metadata, and different AI agents are tasked with selecting from candidate items of pending work for execution than those that are tasked with either analyzing pending work and generating and/or evaluating process control metadata.

The one or more AI agents may operate specific to a specific portion of a workflow or specific to a certain type of information or use case. For example, an artificial intelligence agent may be trained only using information relating to importing invoices, in which case the artificial intelligence agent may be specific to the handling of candidate items of pending work and/or process control metadata relating to importing invoices. In another example, an artificial intelligence agent may be assigned to support the handling the analysis of pending work items, with other agents tasked with supporting generating and/or analyzing process control metadata and executing work items.

The artificial intelligence agents may have different tools or accesses to process information based on their use case. For example, a first artificial intelligence agent may have access to append to a queue of pending work items, and a second artificial intelligence agent may have access to remove pending work items from the queue. A third artificial intelligence agent may have access to a set of process control metadata or influencers that help determine which pending work items should be executed first. Each of these example artificial intelligence agents may or may not have access to perform the functionality provided by the other artificial intelligence agents in the agentic architecture.

In one embodiment, a supervising or managing agent determines one or more types of information being analyzed or one or more decisions being resolved, and the supervising agent assigns one or more worker agents specialized to handle each of the one or more types of information or decisions determined to be relevant. The worker agents may analyze the information with the assistance of generative artificial intelligence, one or more customized prompt templates optionally specific to the corresponding worker agent, and/or one or more customized tools optionally specific to the to the corresponding worker agent. The managing agent may then assemble results from the one or more worker agents to provide a cohesive analysis of the information. For example, some type-specific agents may select candidate work items of their corresponding types for execution, and the supervisor agent may assemble a larger set of candidate work items for execution such that the larger set of work items includes items of different types. As another example, some workflow-specific agents may perform processing of candidate work items and/or process control metadata, and results of the workflow-specific agents may be used to execute the candidate work items in a particular order.

The one or more artificial intelligence agents may perform additional tasks prior to or after prompting a large language model to analyze information. For example, an artificial intelligence agent used for eliminating redundant tasks may perform an extra step prior to generating a prompt to prepare tasks for execution, and this extra step may reduce a number of tasks needed to be prepared for execution. In another example, the same artificial intelligence agent may, after generating a prompt and prompting a large language model to identify and eliminate redundant tasks, perform an extra step of analyzing, clustering, or summarizing the remaining tasks. The additional tasks may be facilitated by a set of tools accessible by the one or more artificial intelligence agents such as access to submit API calls, other machine learning models, templates, or access to further artificial intelligence agents.

Access to the set of tools by artificial intelligence agents may be managed by using one or more authentication keys. The one or more authentication keys may determine which artificial intelligence agents access which tools by controlling access to the authentication keys for each artificial intelligence agent. A first artificial intelligence agent may, for example, have access to an API as a tool via access to one or more authentication keys that are inaccessible to a second artificial intelligence agent. The authentication keys may be simple, static credentials issued to identify applications accessing a tool such as an API. The authentication key may be included in an access request to a tool such as in a request header or URL parameter to an API. An authentication key may also be a temporary access token granted after authentication such that access to the tool is time-limited. An authentication key may also be a credential of a set of credentials such as a username and password, such as for accessing a tool via a user's login, where the user is the current user requesting a summary to be generated by the artificial intelligence agent. Other means of authentication for artificial intelligence agent access to tools may include JSON Web Tokens, Mutual TLS, or Hash-managed Message Authentication Code.

In various embodiments, different agents may have access to different authentication mechanisms and/or different authentication keys, shared secrets, or other authentication parameters, which may provide different levels of access to the different agents. For example, a pending work agent may have access to a first set of tool(s) that use a first set of data to support requests for the pending work agent, a process control metadata agent may have access to a second set of tool(s) that use a second set of data to support requests for the process control metadata agent, and an execution agent may have access to a third set of tool(s) that use a third set of data to support requests for the execution agent. The same or different level(s) of access to same or different tool(s) may be driven by same or different authentication parameter(s) used by the different agents, and the authentication parameter(s) may be communicated to same or different API(s) that support tool functionality, which may have access to same or different set(s) of data in a back-end database, such as access that is driven by role(s) or security profile(s) associated with the authentication parameters provided to authenticate for API use and/or separate role(s) or security profile(s) managed by the tool that provides data lookup, analysis, management, data generation or other content generation, or other functionality to the agent(s).

In some examples, an AI agent can use an API authentication mechanism to ensure secure access to APIs or other data server interfaces accessible via an agent tool by verifying the identity of clients making requests. For example, API keys may include credentials issued to identify clients accessing an API, and may be included in request headers, URL parameters, etc., without necessarily having a built-in expiration or user-based access control. In another example, bearer tokens (e.g., OAuth 2.0, etc.) may include temporary access tokens (e.g., granted after a more comprehensive authentication such as OAuth 2.0), allowing secure, time-limited access to resources (e.g., agent tools) without necessarily exposing credentials. Other methods for accessing agent tools may include ‘Basic Authentication’, which is a process that involves sending a username and password encoded in a request (e.g., HTTP request, HTTPS request, etc.). Another example authentication mechanism includes JSON Web Tokens (JWT), which encode user information for token-based authentication. Another example authentication mechanism includes Mutual TLS (mTLS) which could add an extra layer of security by requiring client and server devices to authenticate each other using certificates. Another example authentication mechanism includes Hash-based Message authentication code (HMAC), where message integrity may be ensured by signing requests with a secret key. Other authentication mechanisms are possible as well depending on security requirements or preferences, user-specific access requirements or preferences, and/or sensitivity of data retrieved using the agent tools, among other factors.

The set of tools accessible by the one or more artificial intelligence agents may be specific to the artificial intelligence agent or the use case of the artificial intelligence agent, such as access to view or modify a pending work queue, access to generate, view, or modify process control metadata, and/or access to view or modify execution history. The set of tools accessible by the one or more artificial intelligence agents may also be a generic tool used to facilitate any artificial intelligence agent in the performance of tasks specific to their use case, such as a data search tool used by an artificial intelligence agent to determine the specific parameters or sets of data relevant to its use case.

In one example, the one or more artificial intelligence agents includes a supervising artificial intelligence agent, which instantiates each of the one or more artificial intelligence agents used in preparing or executing pending work items or analyzing pending work in light of process control metadata. The supervising artificial intelligence agent may determine a number of other artificial intelligence agents necessary to prepare, analyze, and execute pending work, and/or a type of pending work that given agent(s) are in charge of preparing, analyzing, or executing in a multi-agent architecture.

The one or more artificial intelligence agents may communicate between each other by sharing information, derived analyses or generated summaries. For example, a first artificial intelligence agent may be tasked with performing data operations on pending work items, such as by applying one or more deterministic operations to generate, update, or analyze pending work items, the results of which the first artificial intelligence agent gives to a second artificial intelligence agent for further analysis, such as by generating a prompt to a large language model and/or comparison with process control metadata. Result(s) generated by the second artificial intelligence agent may be sent to or retrieved by a third artificial intelligence agent, which executes pending work items. In one example, a number of artificial intelligence worker agents may analyze, summarize, order, or mark pending work items, and a supervising agent may select an item for execution based on the data generated from the worker agents.

### AGENTIC ARCHITECTURE FOR SELF-ORCHESTRATING ASYNCHRONOUS ACTIVITIES TO KEEP DATA UP-TO-DATE AT AN ADAPTIVELY VARIABLE TYPE-SPECIFIC CADENCE BASED ON PROCESS CONTROL METADATA

In various embodiments, an agentic architecture includes multiple artificially intelligent agents that communicate with each other and work together to self-orchestrate asynchronous activities to keep data up-to-date at an adaptively variable type-specific cadence based on process control metadata. The agentic architecture may include a supervising agent, and/or various worker agents such as a pending work agent, process control metadata agent, execution agent, workload pre-processing agent, workload post-processing agent, and/or a learning agent configured to learn from historical data, any of which may be configured to be type-specific for handling only that workload of a specific type or generically able to handle their agentic activities for the full workload of different types.

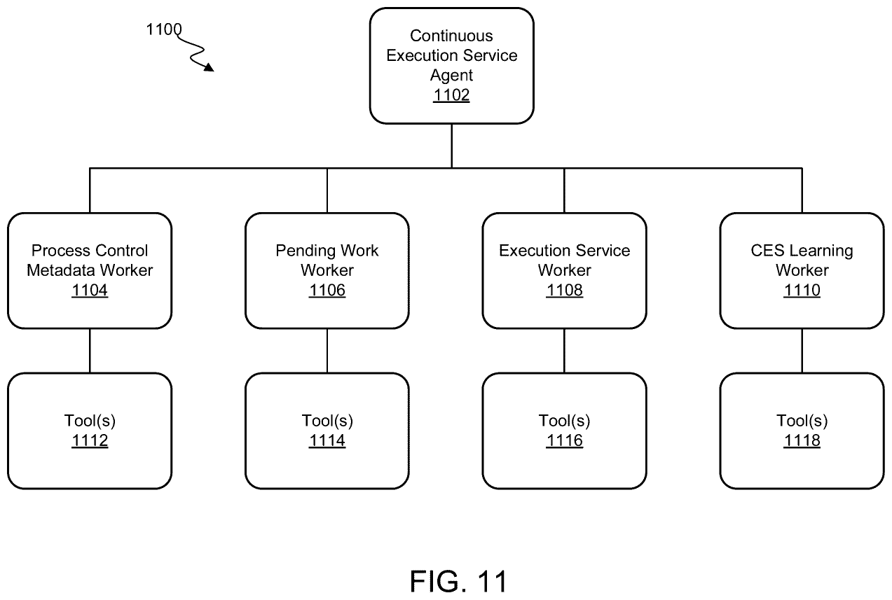

FIG. 11 illustrates an example agentic architecture for executing work items from a pending work queue. In the example shown, supervisor agent 1102 is a continuous execution service agent 1102 that manages a process control metadata worker 1104 with access to corresponding tool(s) 1112 for updating or accessing process control metadata, a pending work worker 1106 with access to corresponding tool(s) 1114 for updating or accessing pending work, an execution service worker 1108 with access to corresponding tool(s) 1116 for selecting pending work for execution, and a CES learning worker 1110 with access to corresponding tool(s) 1118 for learning from historical execution data, process control metadata, and/or pending work data.

In one embodiment, the agentic architecture includes a supervising agent. In various embodiments, the supervising agent monitors the worker agents to ensure that the worker agents are activated to process items of work or process control metadata at a time that such items of work or process control metadata are ready to be processed, and/or periodically according to a wake period that is configurable by the supervising agent. In an example, the supervising agent includes a headless scheduler that wakes up agents according to a wake period to ensure that iterations of pending work updates, process control metadata updates, and/or work execution are frequent enough to keep up with the pending work queue and comply with the process control metadata items. In another embodiment, another agent may include a headless scheduler that self-wakes the other agent to perform work.

In one embodiment, the agentic architecture includes a transaction generation and/or submission agent that requests execution of a transaction by initiating the transaction to be added to a work queue. In another embodiment, transaction generation may be external to the agentic architecture (e.g., such as an external enterprise resource planning (ERP) or human capital management (HCM) application), and the agentic architecture may be specialized for executing transaction requests that have already been generated.

In one embodiment, the agentic architecture includes a pending work agent that generates, analyzes, reads, orders, deletes, and/or updates pending work items, for example, by grouping the pending work items, deduplicating the pending work items, ordering the pending work items, and/or annotating the pending work items with process execution metadata. The pending work agent may include tools to support each of the operations of generating, analyzing, reading, ordering, deleting, and/or updating pending work items such that the pending work agent may effectively manage a queue of pending work items.

The pending work agent may also consume messages about pending work items, such as messages stated in natural language or in a variety of work item specification formats in order to generate a queue of pending work items in a format expected by an execution agent. In this manner, the pending work agent may simplify a heterogenous system of transaction inputs for an execution agent that does not need to have logic for understanding where the pending work item came from or how the pending work item ended up in the queue of pending work items.

The pending work items may be added to a queue by the pending work agent along with information identifying a type of each work item and a timestamp in which the work item was received. The pending work items may be analyzed by a process control metadata agent and/or execution agent to determine which process control metadata items are relevant to the pending work items in the queue and when the different work items in the queue need to be executed, potentially out-of-order, based on the process control metadata items.

In one embodiment, the pending work agent may receive multiple different messages from different systems (e.g., supply chain systems, external systems, project systems, etc.) requesting work to be performed through the agentic architecture. The pending work agent may group the pending work items (e.g., by business unit or type) to merge, consolidate, deduplicate, and/or eliminate redundancies in a number of pending work items otherwise headed to the queue based on incoming messages. For example, if completed transactions are to be aggregated into a metric at least once every hour according to an process control metadata item, the pending work agent may add a new item of pending work to the queue when a first transaction is received after a last aggregation was performed. The pending work agent may merge other transactions to be aggregated into the same item of pending work, which may be picked up by the execution agent at least once every hour according to the process control metadata item. In the example, the pending work agent may group items of the same type or pertaining to the same periodic operation to limit a number of pending work items to be executed by the execution agent.

In one embodiment, the pending work agent accesses a plurality of work items. The pending work agent may generate a prompt for a natural language model. The prompt may identify multiple (e.g., at least two) of the plurality of work items and request a consolidation from among the identified work items. A response to the prompt includes a reduced or grouped subset of the identified work items. The pending work agent determines a subset of the plurality of work items based at least in part on the response and updates the pending work items to include the subset. Further redundancy elimination may be performed, for example, to prevent adding duplicate work items to the pending work items, with or without use of a natural language model.

In one embodiment, the agentic architecture includes a process control metadata agent that updates process control metadata that may guide timing, criticality, or other impact considerations or influencers of when and/or how to execute which work items. The process control metadata agent may consume process control metadata that indicates a data type or relevant ledger for a periodic update operation and optionally a time, frequency, volume, or other process execution condition or consideration for the periodic update operation. For example, the process control metadata may be provided by a user in natural language via a chat interface (externally from the agentic system to the process control metadata agent, user-to-agent), and the process control metadata agent may store an update to an influencers table or other process control metadata table to keep track of timing, frequency, volume, or other impacts or analyses of periodic updates. For example, a user may specify via a chat interface to “create a accounting for ledger XYZ daily by a particular time,” or “decrease a frequency of processing of import payable supplier invoices” and the process control metadata agent may store an update to an influencer table to indicate that the accounting should be created within on or before the particular time every day, or that the period of processing import payable supplier invoices should be increased (e.g., due to decreased frequency). In one example, the influencer table may be consumed by an execution agent to ensure that any work items relevant to the accounting are expedited if they are received prior to the particular time. In the second example, a process control metadata item for processing import payable supplier invoices may be updated such that the maximum processing period is 2 or 4 hours instead of 1 hour. The process control metadata agent may include tools to convert a natural language request to identify named entities from a user request, convert the named entities and natural language request to structured data in support of creating a process control metadata item, and creating process control metadata item, for example, in a process control metadata table such as an influencers table.

In one embodiment, the process control metadata agent interacts (internally, agent-to-agent) with an execution agent to provide an analysis or grouping of process control metadata items that may affect pending work items. The execution agent may ask questions to the process control metadata agent relevant to the process control metadata items, and/or the process control metadata agent may interact with the execution agent to retrieve information relevant to how the process control metadata items affect execution of pending work items or otherwise analysis and grouping of execution history. Information from the process control metadata agent about process control metadata items may be used by the execution agent to improve efficiency of selecting work items in compliance with the process control metadata items. Information from the execution agent about execution history may be stored by the process control metadata agent in association with the process control metadata items for further analysis.

In one embodiment, the process control metadata agent accesses natural language input describing the timing for performing an individual process, for example, such as input received via a chat interface. Other natural language input such as that describing how or under what conditions to perform the individual process may alternatively or additionally be received. The process control metadata agent generates a prompt for a natural language model such as a large language model. The prompt may include the natural language input and a schema of the process control metadata, such as fields expected to be filled in for the process control metadata. In one embodiment, the schema is provided in JSON format in the prompt. The process control metadata agent may receive a response to the prompt, optionally validate the response, and update the process control metadata based at least in part on the response. For example, the process control metadata agent may update the field values of a process control metadata table based on the field values specified in a JSON-formatted response.

In one embodiment, the agentic architecture includes an execution agent that may be operating behind the scenes to consume process execution metadata or other process control metadata determined by the process control metadata agent and performs the work items determined or updated by the pending work agent. The execution agent determines how many execution items may be handled in a given period and which work items may be slotted into the available slots for executing items in the given period.

The execution agent may keep track of how much time has passed since a last execution of a type of work item and which work items are “due” for execution with upcoming deadlines indicated by the conditions specified in the process control metadata items (e.g., in the influencers table) in light of how much time has passed. Even if a given type of work item is not “due,” the execution agent may execute the type of work item ahead-of-schedule to allow more execution cycles to be available for other work items that are coming due in upcoming execution iterations. In one example, the execution agent keeps track of a table of how frequently different types of work items have been executed and accesses process control metadata to determine whether the different types of work items need to be revisited or re-executed at a current iteration or in an upcoming iteration. The execution agent may then plan accordingly to schedule the work item into an execution slot that is available at a current iteration or in an upcoming iteration. In a particular example, the execution agent keeps track of the last execution times directly in the influencers table that includes information about different types of work items and condition(s) or rule(s) associated with the different types of work items. In this example, when the execution agent executes a work item of a given type, the execution agent may update the influencers table to indicate a current time as a last time the work item of that type was executed. In a further embodiment, another column of the influencers table may be automatically updated to list a latest next time that a work item of that type may be executed, for example, using a formula field that is based on the last time the work item of that type was executed (e.g., “[last time executed]+4 hours”). In various other embodiments, one or more agent(s) that may include the execution agent or another agent may update a table such as the influencers table to indicate a last execution time and/or a next expected execution time.

FIG. 7B depicts an example table storing influencer metadata for different processes including a last and next column for tracking when a process type is due for execution. As shown, an import project costs process for “third party sources” runs at least “every 4 hours” as long as there is work to process (“>0”). The process of that type ran on May 1, 2025, at 3:30 p.m. and is next due to run by 7:30 p.m. the same day.

The execution agent may go beyond selecting which work items are to be performed but also determine how the work items are to be performed. For example, the execution agent may also determine how many threads should be used to execute different work items based on historical data and a machine learning model that indicates how much each work item may be parallelized in order to obtain greater execution efficiency. For example, the machine learning model may indicate that a work item was historically executed at the same speed whether 5 or 6 threads were assigned to the work item, but faster than if 1-4 threads were assigned to the work item. Accordingly, the execution engine may assign 5 threads to the work item without assigning the sixth thread due to minimal or no expected benefit obtained from the additional resource expenditure.

In another example, the execution agent may determine there are 10,000 work items in the queue and that approximately 1,000 work items may be performed in each job or that approximately 10 jobs may be managed in parallel. Accordingly, the execution agent may initiate 10 different jobs with 10 different execution instances to each perform 1,000 work items so that the 10,000 work items may be completed during the period. In another example, if the execution agent determine that only 5 jobs may be managed in parallel, the 10,000 work items may be assigned to 5 jobs, each with 2,000 work items. In yet another example, the execution agent may determine that a particular work item or group of work items may take 10 minutes to complete but that another group of work items must be completed within the next 5 minutes according to process control metadata for the type corresponding to the other group. In this scenario, the particular work item or group of work items may be postponed in favor of completing the other group of work items, according to the process control metadata.

The execution agent may also prompt a large language model to determine how many slots, threads, or resources might be needed to execute work items even if the work items have never been executed in the agentic architecture before. The large language model may use information about the work item to determine, from a broader context of how operations are executed as is available to the large language model, whether there are any aspects of the work item that may indicate more or fewer resources (CPU time, memory, etc.) are expected to be used, and/or whether more or fewer slots or threads would be beneficial to support execution.

The execution agent may also learn, using a machine learning model managed by the execution agent as a tool, from previous execution items how long different work items take to execute and/or how many resources are required to execute the different work items. The machine learning model may help the execution agent to ensure that execution may be performed for the pending work items within a given amount of time for a particular period and/or to reduce or otherwise optimize an overall amount of time spent by the execution agent executing items. For example, if an update operation is determined to take a considerable amount of time or resources and, according to the process control metadata item is specified to be performed over a longer period of time, the execution agent may efficiently postpone execution of the update operation until closer to when the longer period of time is reached. The execution agent may also learn a benefit of how many work items were able to be merged or deduplicated due to the postponement, thereby preventing additional work by the execution agent altogether.

In one embodiment, the execution agent may keep track of when different work items were executed and, in particular, when work items of different types were executed, such that the execution agent can determine which types of work items are due for execution and which types of work items may be postponed for efficiency. When the execution agent causes execution of a work item, the execution agent may also update an execution log indicating when the work item was last executed and, in particular, when work items of that type were last executed. The execution log may be compared to the process control metadata to determine which work items are due for execution and which work items may be postponed without violating any process control metadata items.

In one embodiment, an execution agent accesses a plurality of pending potential work items. The execution agent generates input to a machine learning model, which may be a natural language model, a Bayesian model, another neural network, or any other machine learning model. The input may include information about multiple (e.g., at least two) of the pending potential work items. The model may score, rank, or select the pending potential work items for execution based on a variety of factors, including an expected amount of resources to be consumed, an amount of time remaining until the pending potential work item needs to be performed, and/or a likelihood of success in executing the pending potential work items. The execution agent may then select a first of the at least two of the pending potential work items for execution prior to a second of the at least two of the pending potential work items based at least in part on an output of the machine learning model.

In various embodiments, different tasks of the execution agent may be performed by different agents. For example, selecting work items may be performed by an execution item selection agent, and determining how to execute items may be performed by an execution plan agent. Logging execution may be performed by an execution logging agent. In a similar manner, different tasks for any of the agents may be performed by different agents.

In one embodiment, the agentic architecture includes a learning agent that analyzes patterns from the pending work items, process control metadata items, and/or execution history to better predict future pending work item(s), changes to or difficulty complying with certain process control metadata item(s), and/or future execution pattern(s) such as patterns that may achieve a more optimal use of resources while still complying with the process control metadata items. The learning agent may monitor activity from each of these sources and feed the activity into a machine learning model. The machine learning model may be trained to detect patterns, trends, anomalies, and/or future data points from the data. The learning agent may learn which work items or types of work items should be processed together, which types of work items should be handled ahead-of-schedule, which changes should be made to the process control metadata items to promote efficiency (e.g., reduce a frequency of performance of a given type of operation), which pending work items or spikes in pending work items contribute to processing anomalies, etc.

### COMPUTER SYSTEM ARCHITECTURE

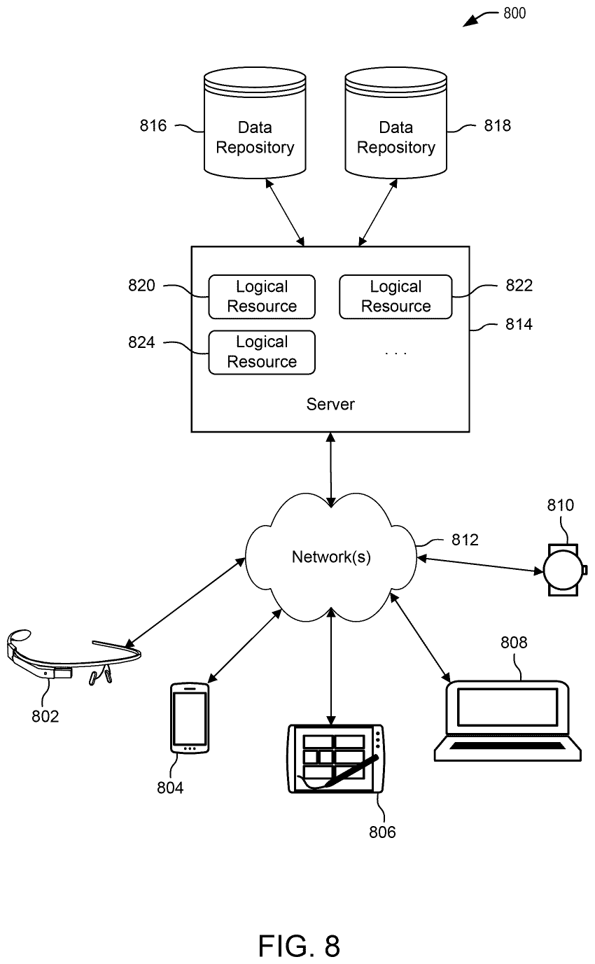

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for efficiently managing asynchronous processes to reduce wasted cycles while maintaining current data for insights and decision-making.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for efficiently managing asynchronous processes to reduce wasted cycles while maintaining current data for insights and decision-making es in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 814 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for efficiently managing asynchronous processes to reduce wasted cycles while maintaining current data for insights and decision-making. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

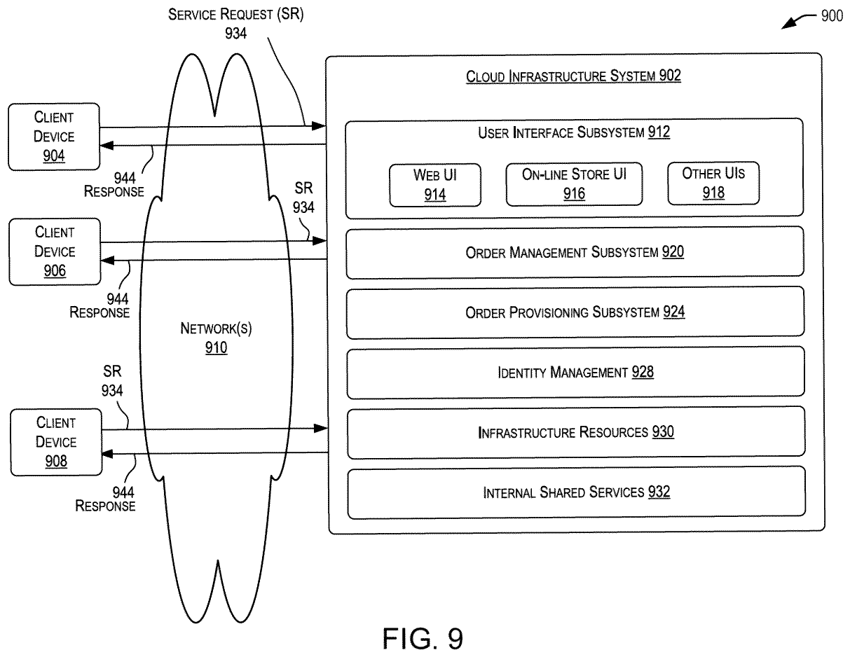

FIG. 9 is a simplified block diagram of a cloud-based system environment in which asynchronous processes are efficiently managed to reduce wasted cycles while maintaining current data for insights and decision-making, in accordance with certain aspects. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may be searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise an order management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the order provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

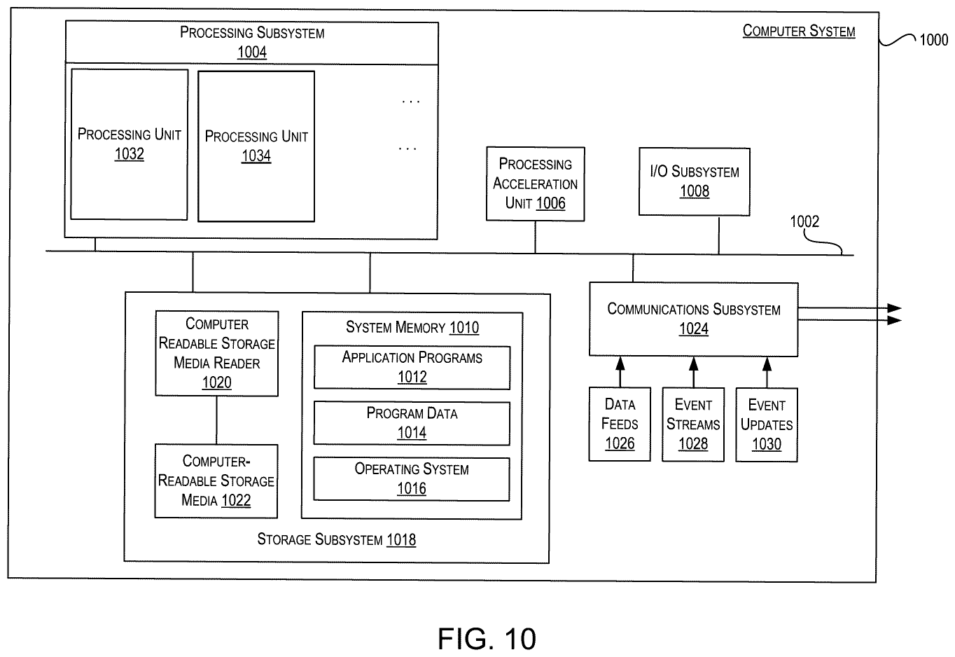

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
tracking pending potential work items due to one or more changes in source data;
activating an asynchronous process management process after a wait period;
determining, by the asynchronous process management process based on process control metadata, which pending potential work items to perform in an iteration of evaluation of the pending potential work items; wherein the process control metadata comprises, for each individual process of two or more processes, one or more stored limitations on a timing for performing the individual process;
postponing, by the asynchronous process management process, performance of at least one item of the pending potential work items for at least a first process based on the process control metadata; wherein postponing the at least one item of the pending potential work items comprises storing the at least one item in a remaining set of pending potential work items;
selecting, by the asynchronous process management process, at least one other item of the pending potential work items for at least a second process based on the process control metadata;
initiating, by the asynchronous process management process, performance of at least one other item of the pending potential work items for at least the second process; wherein initiating performance of the at least one other item of the pending potential work items comprises triggering the second process to consume data based at least in part on the at least one other item of the pending potential work items.

2. The computer-implemented method of claim 1, further comprising accessing, by an agent with access to a natural language model and one or more tools for updating the process control metadata, natural language input describing the timing for performing the individual process; generating a prompt for a natural language model, the prompt comprising the natural language input and a schema of the process control metadata; and updating, by the agent, the process control metadata based at least in part on a response to the prompt.

3. The computer-implemented method of claim 1, further comprising accessing, by an agent with access to a natural language model and one or more tools for updating the pending potential work items, a plurality of work items; generating a prompt for a natural language model, the prompt identifying at least two of the plurality of work items and requesting a consolidation from among the plurality of work items; consolidating, by the agent, the plurality of work items into a subset of the plurality of work items based at least in part on a response to the prompt; and updating the pending work items to include the subset.

4. The computer-implemented method of claim 1, further comprising accessing, by an agent with access to a natural language model and one or more tools for initiating execution of pending potential work items, a plurality of pending potential work items;
generating input to a machine learning model, the input comprising information about at least two of the pending potential work items; and selecting, by the agent, a first of the at least two of the pending potential work items for execution prior to a second of the at least two of the pending potential work items based at least in part on an output of the machine learning model.

5. The computer-implemented method of claim 1, wherein a third process is stored in association with a schedule of a fixed period, the computer-implemented method further comprising marking an iteration of the schedule as completed without initiating the third process and based on a determination, by the asynchronous process management process, that the pending potential work items do not include any work items for the third process.

6. The computer-implemented method of claim 1, wherein the second process is stored in association with a schedule of a fixed period, the computer-implemented method further comprising marking an iteration of the schedule as completed even though the fixed period had not yet passed since a prior iteration of the second process.

7. The computer-implemented method of claim 1, further comprising:
reducing a plurality of candidate processes to a subset of candidate processes comprising the at least the first process and the at least the second process, wherein the subset excludes at least a third process; wherein the reducing is performed by the asynchronous process management process based at least in part on a determination that the pending potential work items do not include any work items for the at least the third process;
determining, by the asynchronous process management process, that available resources for execution do not accommodate both the at least the first process and the at least the second process; and
wherein the postponing the performance of the at least one item of the pending potential work items for the at least the first process is based at least in part on the determining that the available resources for execution do not accommodate both the at least the first process and the at least the second process.

8. The computer-implemented method of claim 1, further comprising:
causing display of a user interface for updating particular process control metadata for the second process;
receiving input specifying one or more updated conditions for the second process; and
storing the one or more updated conditions in the process control metadata in association with the second process;
wherein the selecting the at least one other item based on the process control metadata accounts for the one or more updated conditions for the second process.

9. The computer-implemented method of claim 1, further comprising:
accessing a process-native scheduling registry of the second process, wherein the second process has process-native scheduling enabled;
disabling the process-native scheduling for the second process;
storing one or more conditions for the second process in the process control metadata;
wherein the initiating the performance based on the process control metadata accounts for the one or more stored conditions for the second process.

10. The computer-implemented method of claim 1, further comprising:
predicting a work quantity for the second process based at least in part on a historical work quantity for the second process;
wherein the selecting the at least one other item based on the process control metadata is based at least in part on the predicted work quantity.

11. The computer-implemented method of claim 1, further comprising:
removing the at least one other item of pending potential work from the pending potential work items;
detecting an error in executing the at least one other item of pending potential work by the second process;
re-adding the at least one other item of pending potential work to the pending potential work items;
re-evaluating the at least one other item of pending potential work in a next iteration of running the asynchronous process management process after another wait period.

12. The computer-implemented method of claim 1, further comprising:
detecting an error in executing the at least one other item of pending potential work by the second process;
marking the at least one other item of pending potential work as erroneous;
triggering a notification to one or more users stored in association with the second process, wherein the notification indicates that the at least one other item of pending potential work encountered the error and will be skipped in at least a next iteration of running the asynchronous process management process;
skipping the at least one other item of pending potential work in the next iteration of running the asynchronous process management process after another wait period.

13. The computer-implemented method of claim 1, further comprising automatically adjusting a number of parallel threads for initiating processes by the asynchronous process management process based at least in part on an amount of system resources for supporting both active user transactions and the processes initiated by the asynchronous process management process; wherein the number of parallel threads is inversely proportional to a particular amount of system resources determined to be supporting the active user transactions.

14. A computer-program product comprising one or more non-transitory machine-readable storage media, including stored instructions configured to cause a computing system to perform a set of actions comprising:
tracking pending potential work items due to one or more changes in source data;
activating an asynchronous process management process after a wait period;
determining, by the asynchronous process management process based on process control metadata, which pending potential work items to perform in an iteration of evaluation of the pending potential work items; wherein the process control metadata comprises, for each individual process of two or more processes, one or more stored limitations on a timing for performing the individual process;
postponing, by the asynchronous process management process, performance of at least one item of the pending potential work items for at least a first process based on the process control metadata; wherein postponing the at least one item of the pending potential work items comprises storing the at least one item in a remaining set of pending potential work items;
selecting, by the asynchronous process management process, at least one other item of the pending potential work items for at least a second process based on the process control metadata;
initiating, by the asynchronous process management process, performance of at least one other item of the pending potential work items for at least the second process; wherein initiating performance of the at least one other item of the pending potential work items comprises triggering the second process to consume data based at least in part on the at least one other item of the pending potential work items.

15. The computer-program product of claim 11, wherein the set of actions further includes accessing, by an agent with access to a natural language model and one or more tools for updating the process control metadata, natural language input describing the timing for performing the individual process; generating a prompt for a natural language model, the prompt comprising the natural language input and a schema of the process control metadata; and
updating, by the agent, the process control metadata based at least in part on a response to the prompt.

16. The computer-program product of claim 11, wherein the set of actions further includes accessing, by an agent with access to a natural language model and one or more tools for updating the pending potential work items, a plurality of work items; generating a prompt for a natural language model, the prompt identifying at least two of the plurality of work items and requesting a consolidation from among the plurality of work items; consolidating, by the agent, the plurality of work items into a subset of the plurality of work items based at least in part on a response to the prompt; and updating the pending work items to include the subset.

17. The computer-program product of claim 11, wherein the set of actions further includes accessing, by an agent with access to a natural language model and one or more tools for initiating execution of pending potential work items, a plurality of pending potential work items; generating input to a machine learning model, the input comprising information about at least two of the pending potential work items; and selecting, by the agent, a first of the at least two of the pending potential work items for execution prior to a second of the at least two of the pending potential work items based at least in part on an output of the machine learning model.

18. A system comprising:
one or more processors;
one or more non-transitory computer-readable media storing instructions, which, when executed by the system, cause the system to perform a set of actions comprising:
tracking pending potential work items due to one or more changes in source data;
activating an asynchronous process management process after a wait period;
determining, by the asynchronous process management process based on process control metadata, which pending potential work items to perform in an iteration of evaluation of the pending potential work items; wherein the process control metadata comprises, for each individual process of two or more processes, one or more stored limitations on a timing for performing the individual process;
postponing, by the asynchronous process management process, performance of at least one item of the pending potential work items for at least a first process based on the process control metadata; wherein postponing the at least one item of the pending potential work items comprises storing the at least one item in a remaining set of pending potential work items;
selecting, by the asynchronous process management process, at least one other item of the pending potential work items for at least a second process based on the process control metadata;
initiating, by the asynchronous process management process, performance of at least one other item of the pending potential work items for at least the second process; wherein initiating performance of the at least one other item of the pending potential work items comprises triggering the second process to consume data based at least in part on the at least one other item of the pending potential work items.

19. The system of claim 18, wherein the set of actions further includes accessing, by an agent with access to a natural language model and one or more tools for updating the process control metadata, natural language input describing the timing for performing the individual process; generating a prompt for a natural language model, the prompt comprising the natural language input and a schema of the process control metadata; and updating, by the agent, the process control metadata based at least in part on a response to the prompt.

20. The system of claim 18, wherein the set of actions further includes accessing, by an agent with access to a natural language model and one or more tools for updating the pending potential work items, a plurality of work items; generating a prompt for a natural language model, the prompt identifying at least two of the plurality of work items and requesting a consolidation from among the plurality of work items; consolidating, by the agent, the plurality of work items into a subset of the plurality of work items based at least in part on a response to the prompt; and updating the pending work items to include the subset.

21. The system of claim 18, wherein the set of actions further includes accessing, by an agent with access to a natural language model and one or more tools for initiating execution of pending potential work items, a plurality of pending potential work items; generating input to a machine learning model, the input comprising information about at least two of the pending potential work items; and selecting, by the agent, a first of the at least two of the pending potential work items for execution prior to a second of the at least two of the pending potential work items based at least in part on an output of the machine learning model.
